(19) United States
(12) Patent Application Publication
(10) Pub. No.: US 2007/0112706 A1
(43) Pub. Date: May 17, 2007

(54) Handicapping in a Bayesian skill scoring framework

(75) Inventors: Ralf Herbrich, Cambridge (GB); Thore Graepel, Cambridge (GB)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/607,482

(22) Filed: Nov. 30, 2006

Related U.S. Application Data
(63) Continuation-in-part of application No. 11/276,226, filed on Feb. 17, 2006.
(63) Continuation of application No. 11/041,752, filed on Jan. 24, 2005, now Pat. No. 7,050,868.
(60) Provisional application No. 60/739,072, filed on Nov. 21, 2005.

(51) Int. Cl. G06F 15/18

(52) U.S. Cl. 706/21

(57) ABSTRACT

A skill scoring frameworks allows for handicapping an individual game player in a gaming environment in preparation of matching the game player with other game players, whether for building teams or assigning competitors, or both. By introducing handicapping into the skill scoring framework, a highly skilled player may select one or more game characteristics (e.g., a less than optimal racing vehicle, reduced character capabilities, etc.) and therefore be assigned a handicap that allows the player to be matched with lower skilled players for competitive game play. Handicaps may apply positively or negatively a player's skill score during the matching stage. Handicaps may also be updated based on the game outcomes of the game play in which they were applied.

### CROSS-REFERENCE TO RELATED APPLICATIONS

This application is a continuation-in-part of U.S. patent application Ser. No. 11/276,226, entitled “Player Ranking with Partial Participation” and filed on Feb. 17, 2006, which is a continuation of U.S. patent application Ser. No. 11/041,752, entitled “Bayesian Scoring” and filed on Jan. 24, 2005, now U.S. Pat. No. 7,050,868, all of which are specifically incorporated herein for all that they disclose and teach.

The parent application, U.S. patent application Ser. No. 11/276,226, further claims benefit of U.S. Provisional Patent Application No. 60/739,072, entitled “Team Matching” and filed Nov. 21, 2005, which is specifically incorporated herein for all that it discloses and teaches.

### BACKGROUND

In ranking players of a game, typical ranking systems simply track the player's skill. For example, Arpad Elo introduced the ELO ranking system, which is used in many two-team gaming environments, such as chess, and the like. In the ELO ranking system, the performance or skill of a player is assumed to be measured by the slowly changing mean of a normally distributed random variable. The value of the mean is estimated from the wins, draws, and losses. The mean value is then linearly updated by comparing the number of actual vs. expected game wins and losses.

### BRIEF DESCRIPTIONS OF THE DRAWINGS

The foregoing aspects and many of the attendant advantages of the described technology will become more readily appreciated as the same become better understood by reference to the following detailed description, when taken in conjunction with the accompanying drawings, wherein:

FIG. 1 is an example computing system for implementing a skill scoring system;

FIG. 2 is a dataflow diagram of an example skill scoring system;

FIG. 3 is an example graph of two latent skill score distributions;

FIG. 4 is an example graph of the joint distribution of the skill scores of two players;

FIG. 5 is a flow chart of an example method of updating skill scores of two players or teams;

FIG. 6 is a flow chart of an example method of matching two players or teams based on their skill score distributions;

FIG. 7 is a flow chart of an example method of updating skill scores of multiple teams;

FIG. 8 is a flow chart of an example method of matching skill scores of multiple teams;

FIG. 9 is a flow chart of an example method of approximating a truncated Gaussian distribution using expectation maximization;

FIG. 10 is a graph of examples of measuring quality of a match;

FIG. 11 is a table of an example ranking matrix A;

FIG. 12 is a table of an example ranking matrix A with partial play.

FIG. 13 is a table of an example ranking matrix A with unknown partial rankings; and

FIG. 14 is a table of an example ranking matrix A incorporating partial rankings.

FIG. 15 illustrates an example system for handicapping skill scores in a gaming environment.

FIG. 16 illustrates example operations for handicapping skill scores in a gaming environment.

### DETAILED DESCRIPTIONS

Exemplary Operating Environment

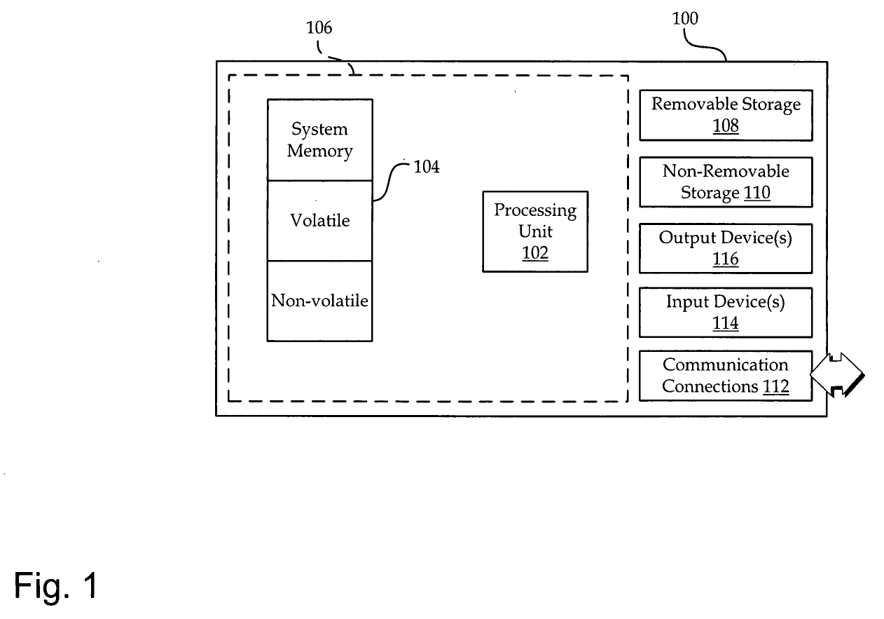

FIG. 1 and the following discussion are intended to provide a brief, general description of a suitable computing environment in which a skill scoring system may be implemented. The operating environment of FIG. 1 is only one example of a suitable operating environment and is not intended to suggest any limitation as to the scope of use or functionality of the operating environment. Other well known computing systems, environments, and/or configurations that may be suitable for use with a skill scoring system described herein include, but are not limited to, personal computers, server computers, hand-held or laptop devices, multiprocessor systems, micro-processor based systems, programmable consumer electronics, network personal computers, mini computers, mainframe computers, distributed computing environments that include any of the above systems or devices, and the like.

Although not required, the skill scoring system will be described in the general context of computer-executable instructions, such as program modules, being executed by one or more computers or other devices. Generally, program modules include routines, programs, objects, components, data structures, etc. that perform particular tasks or implement particular abstract data types. Typically, the functionality of the program modules may be combined or distributed as desired in various environments.

With reference to FIG. 1, an exemplary system for implementing a skill scoring system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106. Additionally, device 100 may also have additional features and/or functionality. For example, device 100 may also include additional storage (e.g., removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules, or other data. Memory 104, removable storage 108, and non-removable storage 110 are all examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also contain communication connection(s) 112 that allow the device 100 to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term ‘modulated data signal’ means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes both storage media and communication media.

Device 100 may also have input device(s) 1114 such as keyboard, mouse, pen, voice input device, touch input device, laser range finder, infra-red cameras, video input devices, and/or any other input device. Output device(s) 116 such as display, speakers, printer, and/or any other output device may also be included.

Skill Scoring System

Players in a gaming environment, particularly electronic on-line gaming environments, may be skill scored relative to each other or to a predetermined skill scoring system. As used herein, the skill score of a player is not a ‘game skill score’ that a player achieves by gaining points or other rewards within a game; but rather, a ranking or other indication of the skill of the player based on the outcome of the game. It should be appreciated that any gaming environment may be suitable for use with the skill scoring system described further below. For example, players of the game may be in communication with a central server through an on-line gaming environment, directly connected to a game console, play a physical world game (e.g., chess, poker, tennis), and the like.

The skill scoring may be used to track a player's progress and/or standing within the gaming environment, and/or may be used to match players with each other in a future game. For example, players with substantially equal skill scores, or skill scores meeting predetermined and/or user defined thresholds, may be matched as opponents to form a substantially equal challenge in the game for each player.

The skill scoring of each player may be based on the outcomes of games among players who compete against each other in teams of one or more. The outcome of each game may update the skill score of each player participating in that game. The outcome of a game may be indicated as a particular winner, a ranked list of participating players, and possibly ties or draws. Each player's skill score on a numerical scale may be represented as a distribution over potential skill scores which may be parameterized for each player by an average skill score μ and a skill score variance σ². The variance may indicate a confidence level in the distribution representing the player's skill score. The skill score distribution for each player may be modeled with a Gaussian distribution and may be determined through a Bayesian inference algorithm.

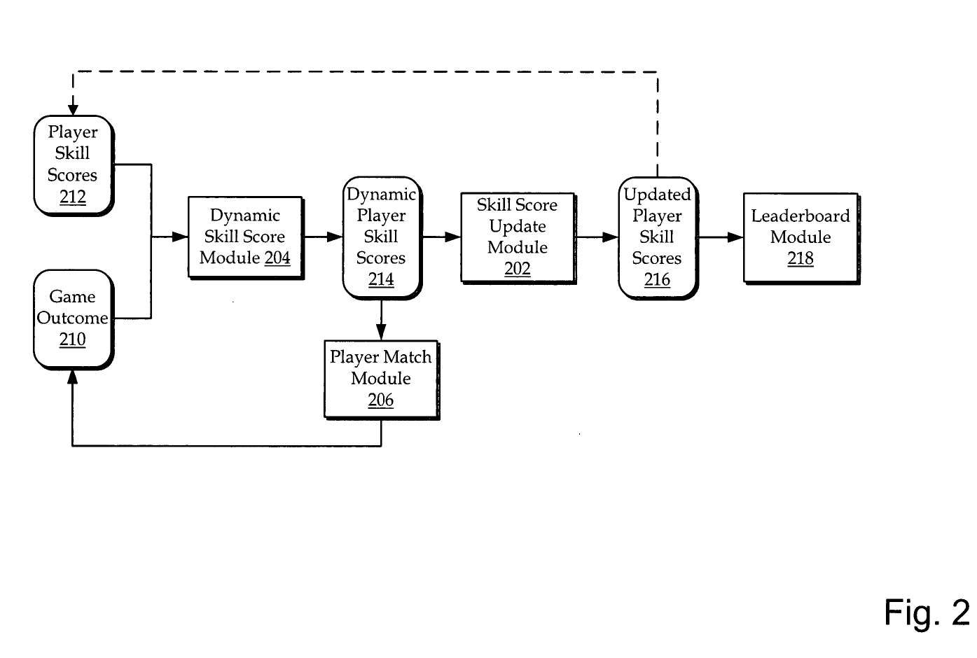

FIG. 2 illustrates an example skill scoring system for determining skill scores for multiple players. Although the following example is discussed with respect to one player opposing another single player in a game to create a game outcome, it should be appreciated that following examples will discuss a team comprising one or more players opposing another team, as well as multi-team games. The skill scoring system 200 of FIG. 2 includes a skill score update module 202 which accepts the outcome 210 of a game between two or more players. It should be appreciated that the game outcome may be received through any suitable method. For example, the outcome may be communicated from the player environment, such as an on-line system, to a central processor to the skill scoring system in any suitable manner, such as through a global communication network. In another example, the skill scores of the opposing player(s) may be communicated to the gaming system of a player hosting the skill scoring system. In this manner, the individual gaming system may receive the skill scores of the opposing players in any suitable manner, such as through a global communication network. In yet another example, the skill scoring system may be a part of the gaming environment, such as a home game system, used by the players to play the game. In yet another example, the game outcome(s) may be manually input into the skill scoring system if the gaming environment is unable to communicate the game outcome to the skill scoring system, e.g., the game is a ‘real’ world game such as board chess.

The game outcome 210 may be an identification of the winning team, the losing team, and/or a tie. For example, if two players (player A and player B) oppose one another in a game, the game outcome may be one of three possible results, player A wins and player B loses; player A loses and player B wins; and players A and B draw. Each player has a skill score 212 which may be updated to an updated skill score 216 in accordance with the possible change over time due to player improvement (or unfortunate atrophy) and the outcome of the game by both the dynamic skill score module 214 and the skill score update module 202. More particularly, where the player skill score 212 is a distribution, the mean and variance of each player's skill score may be updated in view of the outcome and the possible change over time due to player improvement (or unfortunate atrophy). The dynamic skill score module 204 allows the skill score 212 of one or more players to change over time due to player improvement (or unfortunate atrophy). The skill score update module 202, through the outcomes of one or more games, learns the skill score of the player. The player may improve over time, thus, the mean may be increased and/or the variance or confidence in the skill score may be broadened. In this manner, the skill score of each player may be modified to a dynamic player skill score 214 to allow for improvement of the players. The dynamic player skill scores 214 may then be used as input to the skill score update module 202. In this manner, the skill score of each player may be learned over a sequence of games played between two or more players.

The skill score of each player may be used by a player match module 206 to create matches between players based upon factors such as player indicated preferences and/or skill score matching techniques. The matched players, with their dynamic player skill scores 214 or the updated skill scores 216 may then oppose one another and generate another game outcome 210.

A leaderboard module 218 may be used, in some examples, to determine the ranking of two or more players and may provide at least a portion of the ranking list to one or more devices, such as publication of at least a portion of the leaderboard ranking list on a display device, storing the leaderboard ranking list for access by one or more players, and the like.

In some cases, to accurately determine the ranking of a number n of players, at least log(n!), or approximately n log(n) game outcomes may be evaluated. The base of the logarithm depends on the number of unique game outcomes between the two players. In this example, the base is three since there are three possible game outcomes (player A wins, player A lose, and draw). This lower bound of evaluated outcomes may be attained only if each of the game outcomes is fully informative, that is, a priori, the outcomes of the game have a substantially equal probability. Thus, in many games, the players may be matched to have equal strength to increase the knowledge attained from each game outcome. Moreover, the players may appreciate a reasonable challenge from a peer player.

In some cases, there may be m different levels of player rankings. If the number of different levels m is substantially less than the number of players n, then the minimal number of (informative) games may be reduced in some cases to n log(m). More over, if the outcome of a game is the ranking between k teams, then each game may provide up to log(k!) bits, and in this manner, approximately at least

$$\frac{n log ( n )}{log ( k ! )}$$

informative games may be played to extract sufficient information to rank the players.

It is to be appreciated that although the dynamic skill score module 204, the skill score update module 202, the player match module 206 and the leaderboard module 218 are discussed herein as separate components or processes units within the skill scoring system 200, any function or component of the skill scoring system 200 may be provided by any of the other processes or components. Moreover, it is to be appreciated that other skill scoring system configurations may be appropriate. For example, more than one dynamic skill scoring module, skill score update module, skill score vector, and/or player match module may be provided. Likewise, more than one database may be available for storing skill score, rank, and/or game outcomes. Any portion of the modules of the skill scoring system may be hard coded into software supporting the skill scoring system, and/or any portion of the skill scoring system 200 may provided by any computing system which is part of a network or external to a network.

Learning Skill Scores

In a two player game, the outcomes may be player A wins, player A loses, or players A and B draw. The outcome of the game may be indicated in any suitable manner such as through a ranking of the players and/or teams for that particular game. In accordance with the game outcome, each player of a game may be ranked in accordance with a numerical scale. For example, the rank rᵢ of a player may have a value of 1 for the winner and a value of 2 for a loser. In a tie, the two players will have the same rank. In a multi-team example, the players may be enumerated from 1 to n. A game among k teams may be specified by the k indices iⱼε{1, . . . ,n}^{nj} of the nⱼ players in the jth team (nⱼ=1 for games where there are only single players and no multi-player teams) and the rank r achieved by each team may be represented as r:=(rₗ, . . . ,rₖ)^{T}ε{1, . . . ,k}^{k}. Again, the winning team may be assumed to have the rank of 1.

A player's skill score sᵢ may indicate the player's standing relative to a standard scale and/or other players. The skill score may be individual to one or more people acting as a player (i.e., where a “player” represents a team having multiple individual players), or to a game type, a game application, and the like. In some cases, the skill of a team may be a function S(sᵢ_{ⱼ}) of all the skills or skill scores of the players in the jth team. The function may be any suitable function. Where the team includes only a single player, the function S may be the identity function, e.g., S(sᵢ_{ⱼ})=sᵢ.

The skill score sᵢ of each player may have a stochastic transitive property. More particularly, if player i is skill scored above player j, then player i is more likely to win against player j as opposed to player j winning against player i. In mathematical terms:
sᵢ≧sⱼ→P(player i wins)≧P(player j wins) (1)
This stochastic transitive property implies that the probability of player i winning or drawing is greater than or equal to one half because, in any game between two players, there are only three mutually exclusive outcomes (player i wins, loses, or draws).

To estimate the skill score for each player such as in the skill score update module 202 of FIG. 2, a Bayesian learning methodology may be used. With a Bayesian approach, the belief in the true skill score sᵢ of a player may be indicated as a probability density of the skill score (i.e., P(s)). In the following examples, the probability density of the skill score representing the belief in the true skill score is selected as a Gaussian with a mean μ and a diagonal covariance matrix (diag(σ²)). The Gaussian density may be shown as:
P(s)=N(s; μ, diag(σ²)) (2)

Selecting the Gaussian allows the distribution to be unimodal with mode μ. In this manner, a player should not be expected to alternate between widely varying levels of play. Additionally, a Gaussian representation of the skill score may be stored efficiently in memory. In particular, assuming a diagonal covariance matrix effectively leads to allowing each individual skill score for a player i to be represented with two values: the mean μᵢ and the variance σᵢ².

The initial and updated skill scores (e.g., mean μ and variance σ²) of each player may be stored in any suitable manner. For example, the mean and variance of each player may be stored in separate skill score vectors, e.g., a mean vector μ and variance vector σ², a data store, and the like. If all the means and variances for all possible players are stored in vectors, e.g., μ and σ², then the update equations may update only those means and variances associated with the players that participated in the game outcome. Alternatively or additionally, the skill score for each player may be stored in a player profile data store, a skill score matrix, and the like. The skill score for each player may be associated with a player in any suitable manner, including association with a player identifier i, placement or location in the data store may indicate the associated player, and the like.

It is to be appreciated that any suitable data store in any suitable format may be used to store and/or communicate the skill scores and game outcome to the skill scoring system 200, including a relational database, object-oriented database, unstructured database, an in-memory database, or other data store. A storage array may be constructed using a flat file system such as ACSII text, a binary file, data transmitted across a communication network, or any other file system. Notwithstanding these possible implementations of the foregoing data stores, the term data store and storage array as used herein refer to any data that is collected and stored in any manner accessible by a computer.

The Gaussian model of the distribution may allow efficient update equations for the mean μᵢ and the variance σ²ᵢ as the skill scoring system is learning the skill score for each player. After observing the outcome of a game, e.g., indicated by the rank r of the players for that game, the belief distribution or density P(s) in the skill scores s (e.g., skill score sᵢ for player i and skill score sⱼ for player j) may be updated using Bayes rule given by:

$$P ( s \vert r , \{ {i}_{1} , … , {i}_{k} \} ) = \frac{P ( r \vert s , \{ {i}_{1} , … , {i}_{k} \} ) P ( s \vert \{ {i}_{1} , … , {i}_{k} \} )}{P ( r \vert \{ {i}_{1} , … , {i}_{k} \} )} = \frac{P ( r \vert {s}_{{i}_{1}} , … , {s}_{{i}_{k}} ) P ( s )}{P ( r \vert \{ {i}_{1} , … , {i}_{k} \} )} \qquad ( 3 )$$

where the variable iₖ is an identifier or indicator for each player of the team k participating in the game. In the two player example, the vector i₁ for the first team is an indicator for player A and the vector i₂ for the second team is an indicator for player B. In the multiple player example discussed further below, the vector i may be more than one for each team. In the multiple team example discussed further below, the number of teams k may be greater than two. In a multiple team example of equation (3), the probability of the ranking given the skill scores of the players P(r|{sᵢ_{₁}, . . . , sᵢ_{ₖ}}) may be modified given the skill scores of the team S(Sᵢₖ) which is a function of the skill scores of the individual players of the team.

The new updated belief, P(s|r, {iₗ, . . . ,iₖ}) is also called the posterior belief (e.g., the updated skill scores 214, 216) and may be used in place of the prior belief P(s), e.g., the player skill scores 212 in the evaluation of the next game for those opponents. Such a methodology is known as on-line learning, e.g., over time only one belief distribution P(s) is maintained and each observed game outcome r for the players participating {iₗ, . . . iₖ} is incorporated into the belief distribution.

After incorporation into the determination of the players' skill scores, the outcome of the game may be disregarded. However, the game outcome r may not be fully encapsulated into the determination of each player's skill score. More particularly, the posterior belief P(s|r, {iₗ, . . . ,iₖ}) may not be represented in a compact and efficient manner, and may not be computed exactly. In this case, a best approximation of the true posterior may be determined using any suitable approximation technique including expectation propagation, variational inference, assumed density filtering, Laplace approximation, maximum likelihood, and the like. Assumed Density Filtering (ADF) computes the best approximation to the true posterior in some family that enjoys a compact representation—such as a Gaussian distribution with a diagonal covariance. This best approximation may be used as the new prior distribution. The examples below are discussed with reference to assumed density filtering solved either through numerical integration and/or expectation propagation.

Gaussian Distribution

The belief in the skill score of each player may be based on a Gaussian distribution. A Gaussian density having n dimensions is defined by:

$$N ( x ; μ , \sum ) = {( 2 π )}^{\frac{n}{2}} {\vert \sum \vert}^{- \frac{1}{2}} exp ( - \frac{1}{2} {( x - μ )}^{T} {\sum }^{- 1} ( x - μ ) ) \qquad ( 4 )$$

The Gaussian of N(x) may be defined as a shorthand notation for a Gaussian defined by N(x;0, I), where I is the unit matrix. The cumulative Gaussian distribution function may be indicated by Φ(t; μ, σ²) which is defined by:

$$Φ ( t ; μ , {σ}^{2} ) = {P}_{x ≅ N ( x ; μ , {σ}^{2} )} ( x \leq t ) = {\int }_{- ∞}^{t} N ( x ; μ , {σ}^{2} ) ⅆ x \qquad ( 5 )$$

Again, the shorthand of Φ(t) indicates a cumulative distribution of Φ(t;0,1). The notation of [symbol] f(x) [symbol] _{x˜P} denotes the expectation of f over the random draw of x, that is [symbol] f(x) [symbol] _{x·P}=∫f(x)dP(x). The posterior probability of the outcome given the skill scores or the probability of the skill scores given the outcome may not be a Gaussian. Thus, the posterior may be estimated by finding the best Gaussian such that the Kullback-Leibler divergence between the true posterior and the Gaussian approximation is minimized. For example, the posterior P(θ|x) may be approximated by N(θ, μ*ₓ, Σₓ) where the superscript* indicates that the approximation is optimal for the given x. In this manner, the mean and variance of the approximated Gaussian posterior may be given by:
μ*ₓ=μ+Σgₓ (6)
Σ*ₓ=Σ−Σ(gₓg^{T}ₓ−2Gₓ)Σ (7)
where the vector gₓ and the matrix Gₓ are given by:

$$\begin{matrix}{g}_{x} = \frac{\partial log ( {Z}_{x} ( \tilde{μ} , \tilde{\sum } ) )}{\partial \tilde{μ}} {\vert}_{\tilde{μ} = μ , \tilde{\sum } = \sum } & ( 8 ) \\ {G}_{x} = \frac{\partial log ( {Z}_{x} ( \tilde{μ} , \tilde{\sum } ) )}{\partial \tilde{\sum }} {\vert}_{\tilde{μ} = μ , \tilde{\sum } = \sum } & ( 9 )\end{matrix}$$

and the function Zₓ is defined by:
Zₓ(μ, Σ)=∫tₓ(θ)N(θ; μ, Σ)dθ=P(x) (10)
Rectified Truncated Gaussians

A variable x may be distributed according to a rectified double truncated Gaussian (referred to as “rectified Gaussian” from here on) and annotated by x˜R(x; μ, σ², α, β) if the density of x is given by:

$$\begin{matrix}R ( x ; μ , {σ}^{2} , α , β ) = {I}_{x ∈ ( α , β )} \frac{N ( x ; μ , {σ}^{2} )}{Φ ( β ; μ , {σ}^{2} ) - Φ ( α ; μ , {σ}^{2} )} & ( 11 ) \\ = {I}_{x ∈ ( α , β )} \frac{N ( \frac{x - μ}{σ} )}{σ ( Φ ( \frac{β - μ}{σ} ) - Φ ( \frac{α - μ}{σ} ) )} & ( 12 )\end{matrix}$$

When taking the limit of the variable β as it approaches infinity, the rectified Gaussian may be denoted as R(x; μ, σ², α).

The class of the rectified Gaussian contains the Gaussian family as a limiting case. More particularly, if the limit of the rectified Gaussian is taken as the variable α approaches infinity, then the rectified Gaussian is the Normal Gaussian indicated by N(x; μ, σ²) used as the prior distribution of the skill scores.

The mean of the rectified Gaussian is given by:

$${〈 x 〉}_{x \sim R} = μ + σ v ( \frac{μ}{σ} , \frac{α}{σ} , \frac{β}{σ} ) \qquad ( 13 )$$

where the function v(·,α,β) is given by:

$$v ( t , α , β ) = \frac{N ( α - t ) - N ( β - t )}{Φ ( β - t ) - Φ ( α - t )} \qquad ( 14 )$$

The variance of the rectified Gaussian is given by:

$${〈 {x}^{2} 〉}_{x \sim R} - {( {〈 x 〉}_{x \sim R} )}^{2} = {σ}^{2} ( 1 - w ( \frac{μ}{σ} , \frac{α}{σ} , \frac{β}{σ} ) ) \qquad ( 15 )$$

where the function w(·,α,β) is given by:

$$w ( t , α , β ) = {v}^{2} ( t , α , β ) + \frac{( β - t ) N ( β - t ) - ( α - t ) N ( α - t )}{Φ ( β - t ) - Φ ( α - t )} \qquad ( 16 )$$

As β approaches infinity, the functions v(·,α,β) and w(·,α,β) may be indicated as v(·,α) and w(·,α) and determined using:

$$\begin{matrix}v ( t , α ) = {lim}_{β -> ∞} v ( t , α , β ) = \frac{N ( t - α )}{Φ ( t - α )} & ( 17 ) \\ w ( t , α ) = {lim}_{β -> ∞} w ( t , α , β ) = v ( t , α ) \cdot ( v ( t , α ) - ( t - α ) ) & ( 18 )\end{matrix}$$

These functions may be determined using numerical integration techniques, or any other suitable technique. The function w(·,α) may be a smooth approximation to the indicator function I_{t≦α} and may be always bounded by [0,1]. In contrast, the function v(·,α) may grow roughly like α−t for t<α and may quickly approach zero for P>α.

The auxiliary functions \tilde{v}(t,ε) and \tilde{w}(t,ε) may be determined using:
\tilde{v}(t,ε)=v(t,−ε,ε) (19)
\tilde{w}(t,ε)=w(t,−ε,ε) (20)
Learning Skill Scores Over Time

A Bayesian learning process for a skill scoring system learns the skill scores for each player based upon the outcome of each match played by those players. Bayesian learning may assume that each player's unknown, true skill score is static over time, e.g., that the true player skill scores do not change. Thus, as more games are played by a player, the updated player's skill score 214 of FIG. 2 may reflect a growing certainty in this true skill score. In this manner, each new game played may have less impact or effect on the certainty in the updated player skill score 214.

However, a player may improve (or unfortunately worsen) over time relative to other players and/or a standard scale. In this manner, each player's true skill score is not truly static over time. Thus, the learning process of the skill scoring system may learn not only the true skill score for each player, but may allow for each player's true skill score to change over time due to changed abilities of the player. To account for changed player abilities over time, the posterior belief of the skill scores P(s|r, {ₗ, . . . , iₖ}) may be modified over time. For example, not playing the game for a period of time (e.g., Δt) may allow a player's skills to atrophy or worsen. Thus, the posterior belief of the skill score of a player may be modified based upon any suitable factor, such as the playing history of that player (e.g., time since last played) to determine a dynamic skill score 216 as shown in FIG. 2. More particularly, the posterior belief used as the new prior distribution may be represented as the posterior belief P(sᵢ|Δt) of the skill score of the player with index i, given that he had not played for a time of Δt. Thus, the modified posterior distribution may be represented as:

$$\begin{matrix}P ( {s}_{i} \text{\vert} Δ t ) = \int P ( {s}_{i} \text{\vert} μ ) P ( μ \text{\vert} Δ t ) ⅆ μ \\ = \int N ( {s}_{i} ; μ , {σ}^{2} ) N ( μ ; {μ}_{i} , {τ}^{2} ( Δ t ) ) ⅆ μ \\ = N ( {s}_{i} ; {μ}_{i} , {σ}_{i}^{2} + {τ}^{2} ( Δ t ) )\end{matrix} \qquad ( 21 )$$

where the first term P(sᵢ|μ) is the belief distribution of the skill score of the player with the index i, and the second term P(μ|Δt) quantifies the belief in the change of the unknown true skill score at a time of length Δt since the last update. The function τ(·) is the variance of the true skill score as a function of time not played (e.g., Δt). The function τ(Δt) may be small for small times of Δt to reflect that a player's performance may not change over a small period of non-playing time. This function may increase as Δt increases (e.g., hand-eye coordination may atrophy, etc). In the example below, the dynamic skill score function r may return a constant value τ₀, if the time passed since the last update is greater than zero as this indicates that at least one more game was played. If the time passed is zero, then the function τ may return 0. The constant function τ₀ for the dynamic skill score function τ may be represented as:
τ²(Δt)=I_{Δt>0τ}²₀ (22)
where I is the indicator function.
Inference

The belief in a particular game outcome may be quantified with all knowledge obtained about the skill scores of each player, P(s). More particularly, the outcome of a potential game given the skill scores of selected players may be determined. The belief in an outcome of a game for a selected set of players may be represented as:

$$\begin{matrix}P ( r \text{\vert} \{ {i}_{1} , … , {i}_{k} \} ) = \int P ( r \text{\vert} s , \{ {i}_{1} , … , {i}_{k} \} ) P ( s \text{\vert} \{ {i}_{1} , … , {i}_{k} \} ) ⅆ s \\ = \int P ( r \text{\vert} S ( {s}_{{i}_{1}} ) , … , S ( {s}_{{i}_{k}} ) ) P ( s ) ⅆ s\end{matrix} \qquad ( 23 )$$

where S(sᵢ_{ᵢ}), . . . , S(sᵢ_{ₖ}) is s_{A} and s_{B} for a two payer game. Such a belief in a future outcome may be used in matching players for future games, as discussed further below.
Two Player Example

With two players (player A and player B) opposing one another in a game, the outcome of the game can be summarized in one variable y which is 1 if player A wins, 0 if the players tie, and −1 if player A loses. In this manner, the variable y may be used to uniquely represent the ranks r of the players. In light of equation (3) above, the update algorithm may be derived as a model of the game outcome y given the skill scores s₁ and s₂ as:
P(r|s_{A},s_{B})=P(y(r)|s_{A},s_{B}) (24)
where y(r)=sign(r_{B}−r_{A}), where r_{A} is 1 and r_{B} is 2 if player A wins, and r_{A} is 2 and r_{B} is 1 if player B wins, and r_{A} and r_{B} are both 1 if players A and B tie.

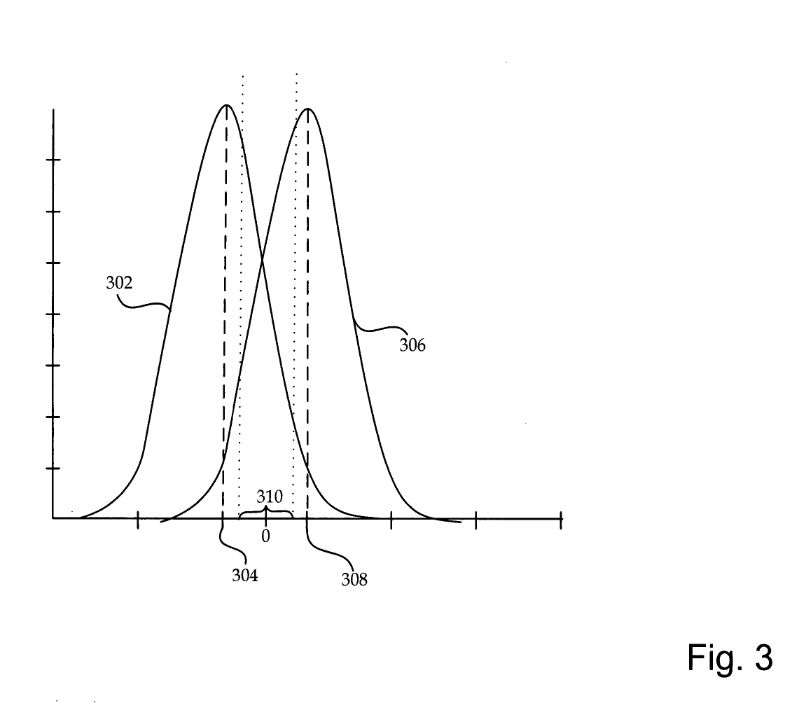

The outcome of the game (e.g., variable y) may be based on the latent skill scores of all participating players (which in the two player example are players A and B). The latent skill score xᵢ may follow a Gaussian distribution with a mean equivalent to the skill score sᵢ of the player with index i, and a fixed latent skill score variance β². More particularly, the latent skill score xᵢ may be represented as N(xᵢ;sᵢ, β²). Graphical representations of the latent skill scores are shown in FIG. 3 as Gaussian curves 302 and 306 respectively. The skill scores s_{A} and s_{B} are illustrated as lines 304 and 308 respectively.

The latent skill scores of the players may be compared to determine the outcome of the game. However, if the difference between the teams is small or approximately zero, then the outcome of the game may be a tie. In this manner, a latent tie margin variable E may be introduced as a fixed number to illustrate this small margin of equality between two competing players. Thus, the outcome of the game may be represented as:
Player A is the winner if: x_{A}>x_{B}+ε (25)
Player B is the winner if: x_{B}>x_{A}+ε (26)
Player A and B tie if: |x_{A}−x_{B}|≦ε (27)
A possible latent tie margin is illustrated in FIG. 3 as the range 310 of width 2ε around zero. In some cases, the latent tie margin may be set to approximately 0, such as in a game where a draw is impracticable, such as a racing game. In other cases, the latent tie margin may be set larger or narrower depending on factors such as the type of game (e.g., capture the flag) team size, and the like.

Since the two latent skill score curves are independent (due to the independence of the latent skill scores for each player), then the probability of an outcome y given the skill scores of the individual players A and B, may be represented as:

$$P ( y \text{\vert} {s}_{A} , {s}_{B} ) = \{ \begin{matrix}P ( Δ < - ɛ ) & if y = - 1 \\ P ( \vert Δ \vert \leq ɛ ) & if y = 0 \\ P ( Δ > ɛ ) & if y = + 1\end{matrix} \qquad \begin{matrix}\begin{matrix}( 28 ) \\ ( 29 )\end{matrix} \\ ( 30 )\end{matrix}$$

where Δ is the difference between the latent skill scores x_{A} and x_{B} (e.g., Δ=x_{A}−x_{B}).

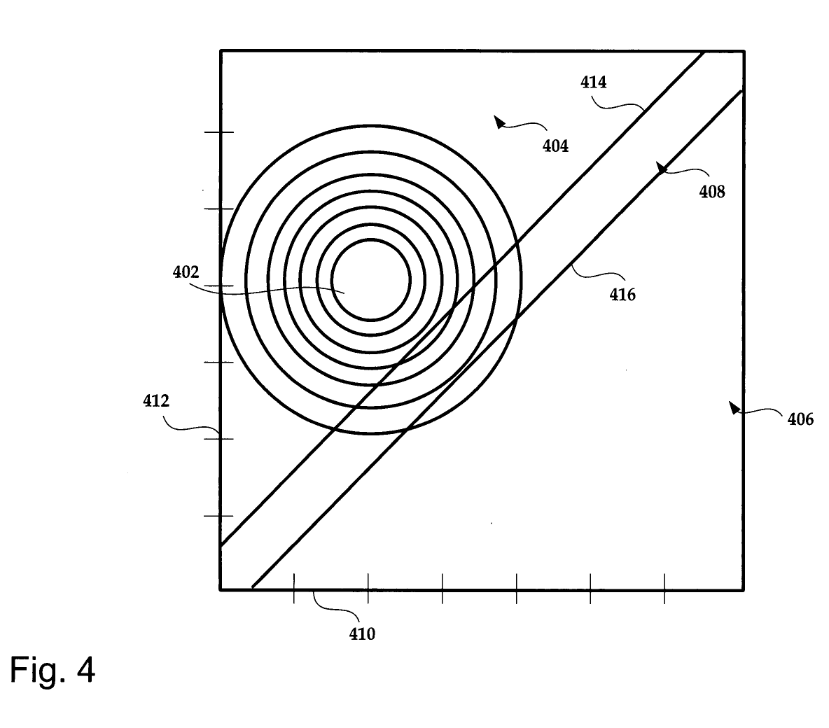

The joint distribution of the latent skill scores for player A and player B are shown in FIG. 4 as contour lines forming a ‘bump’ 402 in a graph with the first axis 410 indicating the latent skill score of player A and the second axis 412 indicating the latent skill score of player B. The placement of the ‘bump’ 402 or joint distribution may indicate the likelihood of player A or B winning by examining the probability mass of the area of the region under the ‘bump’ 402. For example, the probability mass of area 404 above line 414 may indicate that player B is more likely to win, the probability mass of area 406 below line 416 limited by lines 414 and 416 may indicate that player A is more likely to win, and the probability mass of area 408 may indicate that the players are likely to tie. In this manner, the probability mass of area 404 under the joint distribution bump 402 is the probability that player B wins, the probability mass of area 406 under the joint distribution bump 402 is the probability that player A wins, and the probability mass of area 408 under the joint distribution bump 402 is the probability that the players tie. As shown in the example joint distribution 402 of FIG. 4, it is more likely that player B will win.

Two Player Skill Score Update

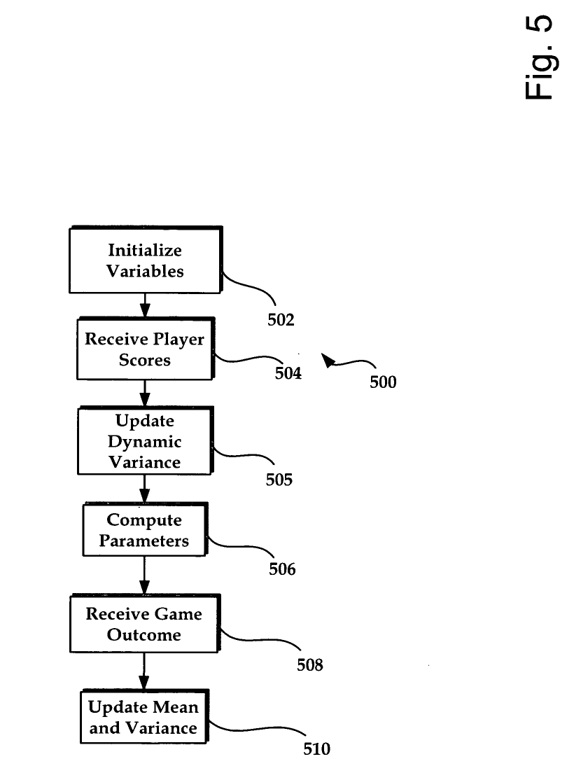

As noted above, the skill score (e.g., mean μᵢ and variance σᵢ²) for each player i (e.g., players A and B), may be updated knowing the outcome of the game between those two players (e.g., players A and B). More particularly, using an ADF approximation, the update of the skill scores of the participating players may follow the method 500 shown in FIG. 5. The static variable(s) may be initialized. For example, the latent tie zone ε, the dynamic time update constant τ₀, and/or the latent skill score variation β may be initialized 502. Example initial values for these parameters may be include: β is within the range of approximately 100 to approximately 400 and in one example may be approximately equal to 250, τ₀ is within the range of approximately 1 to approximately 10 and may be approximately equal to 10 in one example, and ε may depend on many factors such as the draw probability and in one example may be approximately equal to 50. The skill score sᵢ (e.g., represented by the mean μᵢ and variance σᵢ²) may be received 504 for each of the players i, which in the two player example includes mean μ_{A} and variance σ_{A}² for player A and mean μ_{B} and variance σ_{B}² for player B.

Before a player has played a game, the skill score represented by the mean and variance may be initialized to any suitable values. In a simple case, the means may be all initialized at the same value, for example μᵢ=1200. The variance may be initialized to indicate uncertainty about the initialized mean, for example, σ²=400².

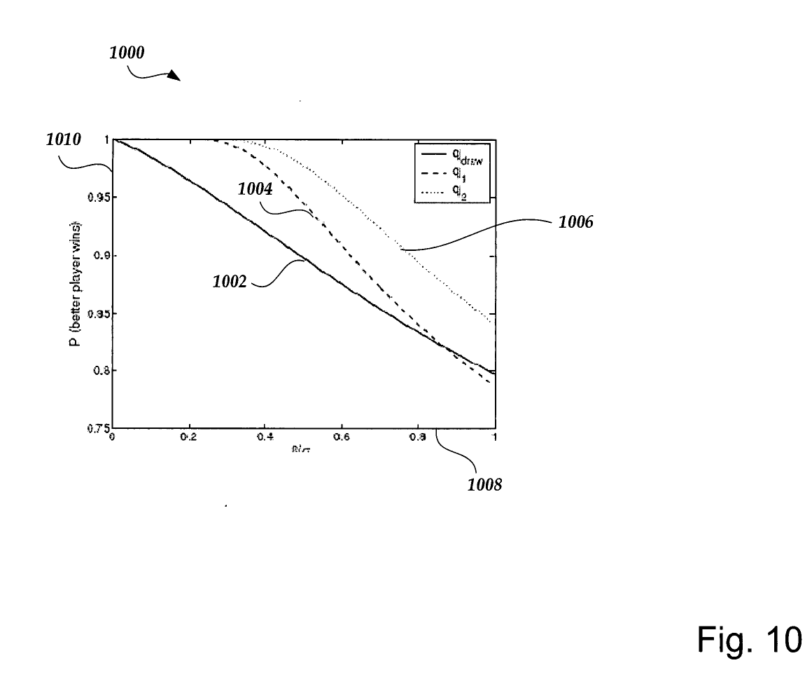

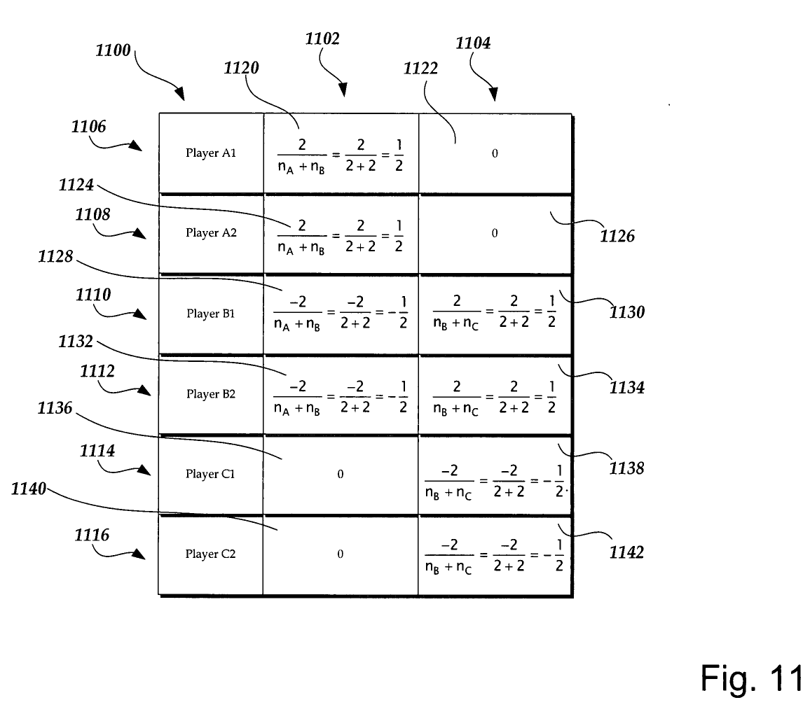

Alternatively, the initial mean and/or variance of a player may be based in whole or in part on the skill score of that player in another game environment. In one implementation, initial skill scores for a new game environment may be seeded by one or more skill scores associated with the player in other game environments. The influence that the skill scores for these other game environments may have in the skill score seeding for the new game environment may be weighted based on a defined compatibility factor with the new game environment. For example, the player skill scores in racing game A and racing game B might have a high compatibility to a new racing game Z. Therefore, they may be weighted more heavily in the skill score seeding for new racing game Z than a first player shooter game C. Nevertheless, the first player shooter game C may be weighted more heavily than a simulation game D. The compatibility factor can be determined based on a game-to-game basis, compatible categories or features, game developer defined parameters, or any combination of considerations. More detailed discussions are provided with regard to FIGS. 10-11.

If the belief is to be updated based on time, as described above, the variance of each participating player's skill score may be updated based on the function T and the time since the player last played. The dynamic time update may be done in the dynamic skill score module 204 of the skill scoring system of FIG. 2. As noted above, the output of the dynamic skill score function r may be a constant To for all times greater than 0. In this manner, τ₀ may be zero on the first time that a player plays a game, and may be the constant τ₀ thereafter. The variance of each player's skill score may be updated 505 by:
σ²ᵢ→σ²ᵢ+τ²₀ (31)

To update the skill scores based on the game outcome, a parameter c may be computed 506 as the sum of the variances, such that parameter c is:
c=(n_{A}+n_{B})β²+σ²_{A}+σ²_{B} (32)
=2β²+σ²_{A}+σ²_{B} (33)
where n_{A} is the number of players in team A (in this example 1) and n_{B} is the number of players in team B (in this example 1).

The parameter h may be computed 506 based on the mean of each player's skill score and the computed parameter c as:

$$\begin{matrix}{h}_{A} = \frac{{μ}_{A} - {μ}_{B}}{\sqrt{c}} & ( 34 ) \\ {h}_{B} = \frac{{μ}_{B} - {μ}_{A}}{\sqrt{c}} & ( 35 )\end{matrix}$$

which, indicates that h_{A}=−h_{B}. The parameter ε′ may be computed 506 based on the number of players, the latent tie zone ε, and the parameter c as:

$${ɛ}^{′} = \frac{ɛ ( {n}_{A} + {n}_{B} )}{2 \sqrt{c}} \qquad ( 36 )$$

And for the two player example, this leads to:

$${ɛ}^{′} = \frac{ɛ}{\sqrt{c}} \qquad ( 37 )$$

The outcome of the game between players A and B may be received 508. For example, the game outcome may be represented as the variable y which is −1 if player B wins, 0 if the players tie, and +1 if player A wins. To change the belief in the skill scores of the participating players, such as in the skill score update module of FIG. 2, the mean and variance of the each skill score may be updated 510. More particularly, if the player A wins (e.g., y=1), then the mean μ_{A} of the winning player A may be updated as:

$${μ}_{A} ← {μ}_{A} + \frac{{σ}_{A}^{2}}{\sqrt{c}} v ( {h}_{A} , {ɛ}^{′} ) \qquad ( 38 )$$

The mean μ_{B} of the losing player B may be updated as:

$${μ}_{B} ← {μ}_{B} - \frac{{σ}_{B}^{2}}{\sqrt{c} } v ( {h}_{A} , {ɛ}^{′} ) \qquad ( 39 )$$

The variance σ²ᵢ of each player i (A and B) may be updated when player A wins as:

$${σ}_{i}^{2} ← {σ}_{i}^{2} ( 1 - \frac{{σ}_{i}^{2}}{c} w ( {h}_{A} , {ɛ}^{′} ) ) \qquad ( 40 )$$

However, if player B wins (e.g., y=−1), then the mean μ_{A} of the losing player A may be updated as:

$${μ}_{A} ← {μ}_{A} - \frac{{σ}_{A}^{2}}{\sqrt{c}} v ( {h}_{B} , {ɛ}^{′} ) \qquad ( 41 )$$

The mean μ_{B} of the winning player B may be updated as:

$${μ}_{B} ← {μ}_{B} + \frac{{σ}_{B}^{2}}{\sqrt{c}} v ( {h}_{B} , {ɛ}^{′} ) \qquad ( 42 )$$

The variance σ²ᵢ of each player i (A and B) may be updated when player B wins as:

$${σ}_{i}^{2} ← {σ}_{i}^{2} ( 1 - \frac{{σ}_{i}^{2}}{c} w ( {h}_{B} , {ɛ}^{′} ) ) \qquad ( 43 )$$

If the players A and B draw, then the mean μ_{A} of the player A may be updated as:

$${μ}_{A} ← {μ}_{A} + \frac{{σ}_{A}^{2}}{\sqrt{c}} \tilde{v} ( {h}_{A} , {ɛ}^{′} ) \qquad ( 44 )$$

The mean μ_{B} of the player B may be updated as:

$${μ}_{B} ← {μ}_{B} + \frac{{σ}_{B}^{2}}{\sqrt{c}} \tilde{v} ( {h}_{B} , {ɛ}^{′} ) \qquad ( 45 )$$

The variance σ²_{A} of player A may be updated when the players tie as:

$${σ}_{A}^{2} ← {σ}_{A}^{2} ( 1 - \frac{{σ}_{A}^{2}}{c} \tilde{w} ( {h}_{A} , {ɛ}^{′} ) ) \qquad ( 46 )$$

The variance σ²_{B} of player B may be updated when the players tie as:

$${σ}_{B}^{2} ← {σ}_{B}^{2} ( 1 - \frac{{σ}_{B}^{2}}{c} \tilde{w} ( {h}_{B} , {ɛ}^{′} ) ) \qquad ( 47 )$$

In equations (38-47) above, the functions v(·), w(·), v(·), and \tilde{w}(·) may be determined from the numerical approximation of a Gaussian. Specifically, functions v(·), w(·), \tilde{v}(·), and \tilde{w}(·) may be evaluated using equations (17-20) above using numerical methods such as those described in Press et al., Numerical Recipes in C: the Art of Scientific Computing (2d. ed.), Cambridge, Cambridge University Press, ISBN-0-521-43108-5, which is incorporated herein by reference, and by any other suitable numeric or analytic method.

The above equations to update the skill score of a player are different from the ELO system in many ways. For example, the ELO system assumes that each player's various is equal, e.g., well known. In another example, the ELO system does not use a variable K factor which depends on the ratio of the uncertainties of the players. In this manner, playing against a player with a certain skill score allows the uncertain player to move up or down in larger steps than in the case when playing against another uncertain-player.

The updated values of the mean and variance of each player's skill score from the skill score update module 202 of FIG. 2 may replace the old values of the mean and variance (skill scores 212). The newly updated mean and variance of each player's skill score incorporate the additional knowledge gained from the outcome of the game between players A and B.

Two Player Matching

The updated beliefs in a player's skill score may be used to predict the outcome of a game between two potential opponents. For example, a player match module 206 shown in FIG. 2 may use the updated and/or maintained skill scores of the players to predict the outcome of a match between any potential players and match those players meeting match criteria, such as approximately equal player skill score means, player indicated preferences, approximately equal probabilities of winning and/or drawing, and the like.

To predict the outcome of a game, the probability of a particular outcome y given the mean skill scores and standard deviations of the skill scores for each potential player, e.g., P(y|s_{A},s_{B}) may be computed. Accordingly, the probability P(y) of the outcome y may be determined from the probability of the outcome given the player skill scores with the skill scores marginalized out.

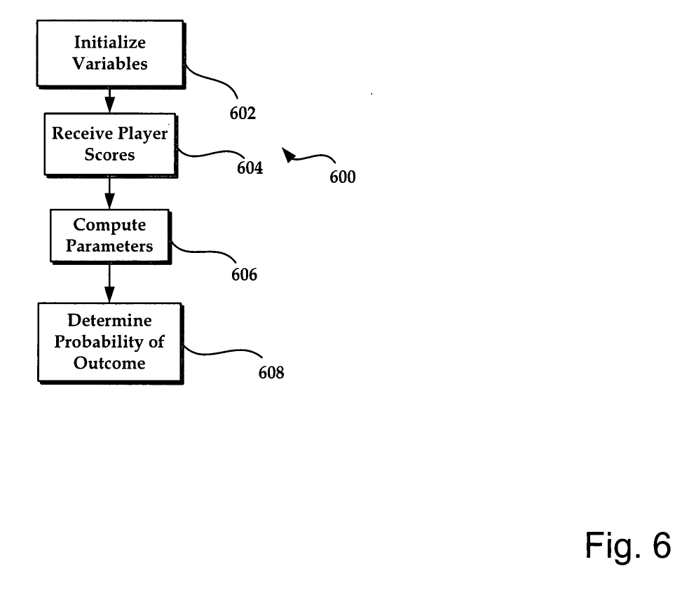

FIG. 6 illustrates an example method 600 of predicting a game outcome between two potential players (player A and player B). The static variable(s) may be initialized 602. For example, the latent tie zone ε, the dynamic time update constant τ₀, and/or the latent skill score variation β may be initialized. The skill score sᵢ (e.g., represented by the means μᵢ and variance σᵢ²) may be received 604 for each of the players i who are participating in the predicted game. In the two player example, the player skill scores include mean μ_{A} and variance σ_{A}² for player A, and mean μ_{B} and variance σ_{B}² for player B.

Parameters may be determined 606. The parameter c may be computed 606 as the sum of the variances using equation (32) or (33) above as appropriate. Equations (32) and (33) for the parameter c may be modified to include the time varying aspects of the player's skill scores, e.g., some time Δt has passed since the last update of the skill scores. The modified parameter c may be computed as:
c=(n_{A}+n_{B})β²+σ_{A}²+σ_{B}²+(n_{A}+n_{B})τ₀ (48)
where n_{A} is the number of players in team A (in this example 1 player) and n_{B} is the number of players in team B (in this example 1 player). The parameter ε′ may be computed using equation (36) or (37) above as appropriate.

The probability of each possible outcome of the game between the potential players may be determined 608. The probability of player A winning may be computed using:

$$P ( y = 1 ) = Φ ( \frac{{μ}_{A} - {μ}_{B} - {ɛ}^{′}}{\sqrt{c}} ) \qquad ( 49 )$$

The probability of player B winning may be computed using:

$$P ( y = - 1 ) = Φ ( \frac{{μ}_{B} - {μ}_{A} - {ɛ}^{′}}{\sqrt{c}} ) \qquad ( 50 )$$

As noted above, the function Φ indicates a cumulative Gaussian distribution function having an argument of the value in the parentheses and a mean of zero and a standard deviation of one. The probability of players A and B having a draw may be computed using:
P(y=0)=1−P(y=1)−P(y=−1) (51)

The determined probabilities of the outcomes may be used to match potential players for a game, such as comparing the probability of either team winning or drawing with a predetermined or user provided threshold or other preference. A predetermined threshold corresponding to the probability of either team winning or drawing may be any suitable value such as approximately 25%. For example, players may be matched to provide a substantially equal distribution over all possible outcomes, their mean skill scores may be approximately equal (e.g., within the latent tie margin), and the like. Additional matching techniques which are also suitable for the two player example are discussed below with reference to the multi-team example.

Two Teams

The two player technique described above may be expanded such that ‘player A’ includes one or more players in team A and ‘player B’ includes one or more players in team B. For example, the players in team A may have any number of players indicated by n_{A}, and team B may have any number of players indicated by n_{B}. A team may be defined as one or more players whose individual performances in the game achieve a single outcome for all the players on the team.

Each player of each team may have an individual skill score sᵢ represented by a mean μᵢ and a variance σᵢ². More particularly, the players of team A may be indicated with the indices i_{A}, and the players of team B may be indicated with the indices i_{B}.

Since there are only two teams, like the two player example above, there may be three possible outcomes to a match, i.e., team A wins, team B wins, and teams A and B tie. Like the latent skill scores of the two player match above, a team latent skill score t(i) of a team with players having indices i is a linear function of the latent skill scores xⱼ of the individual players of the team. For example, the team latent skill score t(i) may equal b(i)^{T} x with b(i) being a vector having n elements. Thus, the outcome of the game may be represented as:
Team A is the winner if: t(i_{A})>t(i_{B})+ε (52)
Team B is the winner if: t(i_{B})>t(i_{A})+ε (53)
Team A and B tie if: t(i_{A})−t(i_{B})|≦ε| (54)
where ε is the latent tie margin discussed above. The probability of the outcome given the skill scores of the teams sᵢ_{_{A}} and sᵢ_{_{B}} is shown in equations (28-30) above. However, in the team example, the term Δ of equations (28-30) above is the difference between the latent skill scores of the teams t(i_{A}) and t(i_{B}). More particularly, the term Δ may be determined as:
Δ=t(i_{A})−t(i_{B})=(b(i_{A})−b(i_{B}))^{T}x=a^{T}x (55)
where x is a vector of the latent skill scores of all players and the vector a comprises linear weighting coefficients.

The linear weighting coefficients of the vector a may be derived in exact form making some assumptions. For example, one assumption may include if a player in a team has a positive latent skill score, then the latent team skill score will increase; and similarly, if a player in a team has a negative latent skill score, then the latent team skill score will decrease. This implies that the vector b(i) is positive in all components of i. The negative latent skill score of an individual allows a team latent skill score to decrease to cope with players who do have a negative impact on the outcome of a game. For example, a player may be a so-called ‘team killer.’ More particularly, a weak player may add more of a target to increase the latent team skill score for the other team than he can contribute himself by skill scoring. The fact that most players contribute positively can be taken into account in the prior probabilities of each individual skill score. Another example assumption may be that players who do not participate in a team (are not playing the match and/or are not on a participating team) should not influence the team skill score. Hence, all components of the vector b(i) not in the vector i should be zero (since the vector x as stored or generated may contain the latent skill scores for all players, whether playing or not). In some cases, only the participating players in a game may be included in the vector x, and in this manner, the vector b(i) may be non-zero and positive for all components (in i). An additional assumption may include that if two players have identical latent skill scores, then including each of them into a given team may change the team latent skill score by the same amount. This may imply that the vector b(i) is a positive constant in all components of i. Another assumption may be that if each team doubles in size and the additional players are replications of the original players (e.g., the new players have the same skill scores sᵢ, then the probability of winning or a draw for either team is unaffected. This may imply that the vector b(i) is equal to the inverse average team size in all components of i such that:

$$b ( i ) = - \frac{2}{{n}_{A} + {n}_{B}} {\sum }_{j ∈ i} {e}_{j} \qquad ( 56 )$$

where the vector e is the unit n-vector with zeros in all components except for component j which is 1, and the terms n_{A} and n_{B} are the numbers in teams A and B respectively. With the four assumptions above, the weighting coefficients a are uniquely determined.

If the teams are equal sized, e.g., n_{A}+n_{B}, then the mean of the latent player skill scores, and hence, the latent player skill scores x, may be translated by an arbitrary amount without a change in the distribution Δ. Thus, the latent player skill scores effectively form an interval scale. However, in some cases, the teams may have uneven numbering, e.g., n_{A} and n_{B} are not equal. In this case, the latent player skill scores live on a ratio scale in the sense that replacing two players each of latent skill score x with one player of latent skill score 2x does not change the latent team skill score. In this manner, a player with mean skill score s is twice as good as a player with mean skill score s/2. Thus, the mean skill scores indicate an average performance of the player. On the other hand, the latent skill scores indicate the actual performance in a particular game and exist on an interval scale because in order to determine the probability of winning, drawing, and losing, only the difference of the team latent skill scores is used, e.g., t(i_{A})−t(i_{B}).

The individual skill score sᵢ represented by the mean μᵢ and variance σᵢ² of each player i in a team participating in a game may be updated based upon the outcome of the game between the two teams. The update equations and method of FIG. 5 for the two player example may be modified for a two team example. With reference to the method 500 of FIG. 5, the latent tie zone E, the dynamic time update constant τ₀, and the latent skill score variation β may be initialized 502 as noted above. Similarly, the skill score sᵢ (e.g., represented by the mean μᵢ and variance σᵢ²) may be received 504 for each of the players i in each of the two teams, which in the two team example includes mean μ_{A}_{ᵢ} and variance σ²_{A}_{ᵢ} for the players i in team A and mean μBᵢ and variance σ²_{B}_{ᵢ} for the players i in team B.

Since the update to the belief based on time depends only on the variance of that player (and possibly the time since that player last played), the variance of each player may be updated 505 using equation (31) above. As noted above, the update based on time may be accomplished through the dynamic skill score module 204 of FIG. 2.

With reference to FIG. 5, the parameters may be computed 506 similar to those described above with some modification to incorporate the team aspect of the skill scores and outcome. The parameter c may be computed 506 as the sum of the variances, as noted above. However, in a two team example where each team may have one or more players, the variances of all players participating in the game must be summed. Thus, for the two team example, equation (32) above may be modified to:

$$c = ( {n}_{A} + {n}_{B} ) {β}^{2} + {\sum }_{i = 1}^{{n}_{A}} {σ}_{{A}_{i}}^{2} {\sum }_{i = 1}^{{n}_{B}} {σ}_{{B}_{i}}^{2} \qquad ( 57 )$$

The parameters h_{A} and h_{B} may be computed 506 as noted above in equations (34-35) based on the mean of each team's skill score μ_{A} and μ_{B}. The team mean skill scores μ_{A} and μ_{B} for teams A and team B respectively may be computed as the sum of the means of the player(s) for each team as:

$$\begin{matrix}{μ}_{A} = {\sum }_{i = 1}^{{n}_{A}} {μ}_{{A}_{i}} & ( 58 ) \\ {μ}_{B} = {\sum }_{i = 1}^{{n}_{B}} {μ}_{{B}_{i}} & ( 59 )\end{matrix}$$

The parameter ε′ may be computed 506 as

$${ɛ}^{′} = \frac{ɛ ( {n}_{A} + {n}_{B} )}{2 \sqrt{c}} \qquad ( 59.1 )$$

where n_{A} is the number of players in team A, n_{B} is the number of players in team B.

The outcome of the game between team A and team B may be received 508. For example, the game outcome may be represented as the variable y which is equal to −1 if team B wins, 0 if the teams tie, and +1 if team A wins. To change the belief in the probability of the previous skill scores of each participating player of each team, the mean and variance of each participating player may be updated 510 by modifying equations (38-46) above. If team A wins the game, then the individual means may be updated as:

$$\begin{matrix}{μ}_{{A}_{i}} ← {μ}_{{A}_{i}} + \frac{{σ}_{{A}_{i}}^{2}}{\sqrt{c}} v ( {h}_{A} , {ɛ}^{′} ) & ( 60 ) \\ {μ}_{{B}_{i}} ← {μ}_{{B}_{i}} - \frac{{σ}_{{B}_{i}}^{2}}{\sqrt{c}} v ( {h}_{A} , {ɛ}^{′} ) & ( 61 )\end{matrix}$$

The variance σ²ᵢ of each player i (of either team A or B) may be updated when team A wins as shown in equation (40) above.

However, if team B wins (e.g., y=−1), then the mean μ_{A}_{ᵢ} of each participating player may be updated as:

$$\begin{matrix}{μ}_{{A}_{i}} ← {μ}_{{A}_{i}} - \frac{{σ}_{{A}_{i}}^{2}}{\sqrt{c}} v ( {h}_{B} , {ɛ}^{′} ) & ( 62 ) \\ {μ}_{{B}_{i}} ← {μ}_{{B}_{i}} + \frac{{σ}_{{B}_{i}}^{2}}{\sqrt{c}} v ( {h}_{B} , {ɛ}^{′} ) & ( 63 )\end{matrix}$$

The variance σ²ᵢ of each player i (of either team A or B) may be updated when team B wins as shown in equation (43) above.

If the teams A and B draw, then the mean μ_{A} and μ_{B} of each player of the teams A and B respectively may be updated as:

$$\begin{matrix}{μ}_{{A}_{i}} ← {μ}_{{A}_{i}} + \frac{{σ}_{{A}_{i}}^{2}}{\sqrt{c}} \tilde{v} ( {h}_{A} , {ɛ}^{′} ) & ( 64 ) \\ {μ}_{{B}_{i}} ← {μ}_{{B}_{i}} + \frac{{σ}_{{B}_{i}}^{2}}{\sqrt{c}} \tilde{v} ( {h}_{B} , {ɛ}^{′} ) & ( 65 )\end{matrix}$$

The variance σ²_{A}_{ᵢ} of each player in team A may be updated when the teams tie as:

$${σ}_{{A}_{i}}^{2} ← {σ}_{{A}_{i}}^{2} ( 1 - \frac{{σ}_{{A}_{i}}^{2}}{c} \tilde{w} ( {h}_{A} , {ɛ}^{′} ) ) \qquad ( 66 )$$

The variance σ²_{B}_{ᵢ} of each player in team B may be updated when the teams tie as:

$${σ}_{{B}_{i}}^{2} ← {σ}_{{B}_{i}}^{2} ( 1 - \frac{{σ}_{{B}_{i}}^{2}}{c} \tilde{w} ( {h}_{B} , {ɛ}^{′} ) ) \qquad ( 67 )$$

As with equations (38-43), the functions v(·), w(−), v(·), and v(·) may be evaluated using equations (17-20) above using numerical methods. In this manner, the updated values of the mean and variance of each player's skill score may replace the old values of the mean and variance to incorporate the additional knowledge gained from the outcome of the game between teams A and B.

Two Team Matching

Like the skill scoring update equations above, the matching method of FIG. 6 may be modified to accommodate two teams of one or more players each. Like above, the static variables may be initialized 602. The skill score sᵢ (represented by the mean μ_{A}_{ᵢ} and μ_{B}_{ᵢ} and the variance σ²_{A}_{ᵢ} and σ²_{B}_{ᵢ} for each player i of each respective team A and B) may be received 604 for each of the players. In addition, the matchmaking criteria may take into account the variability of skill scores within the team. For example, it may be desirable to have teams comprising players having homogeneous skill scores, because in some cases they may better collaborate.

The parameters may be determined 606 as noted above. For example, the parameter c may be computed using equation (57), the mean of each team μ_{A} and μ_{B} may be computed using equations (58) and (59), and ε′ may be computed using equation (36).

The probability of each possible outcome of the game between the two potential teams may be determined 608. The probability of team A winning may be computed using equation (49) above. The probability of team B winning may be computed using equation (50) above. The probability of a draw may be computed using equation (51) above. The determined probabilities of the outcomes may be used to match potential teams for a game, such as comparing the probability of either team winning and/or drawing, the team and/or player ranks, and/or the team and/or player skill scores with a predetermined or user provided threshold.

Multiple Teams

The above techniques may be further expanded to consider a game that includes multiple teams, e.g., two or more opposing teams which may be indicated by the parameter j. The index j indicates the team within the multiple opposing teams and ranges from 1 to k teams, where k indicates the total number of opposing teams. Each team may have one or more players i, and the jth team may have a number of players indicated by the parameter nⱼ and players indicated by iⱼ. Knowing the ranking r of all k teams allows the teams to be re-arranged such that the ranks rⱼ of each team may be placed in rank order. For example, the rank of each team may be placed in rank-decreasing order such that r₍₁₎≦r₍₂₎≦ . . . ≦r₍ₖ₎ where the index operator ( ) is a permutation of the indices j from 1 to k. Since in some cases, the rank of 1 is assumed to indicate the winner of the game, the rank-decreasing order may represent a numerically increasing order. In this manner, the outcome r of the game may be represented in terms of the permutation of team indices and a vector yε{0,+1}^{k-1}. For example, (yⱼ=+1) if team (1) was winning against team (j+1), and (yⱼ=0) if team (j) was drawing against team (j+1). In this manner, the elements of the vector y may be indicated as yⱼ=sign(r₍ⱼ₊₁₎−r₍ⱼ₎).

Like the example above with the two teams, the outcome of the game may be based upon the latent skill scores of all participating players. The latent skill score xᵢ may follow a Gaussian distribution with a mean equivalent to the skill score sᵢ of the player with index i, and a fixed latent skill score variance β². In this manner, the latent skill score xᵢ may be represented by N(xᵢ;sᵢ,β²). The latent skill score t(i) of a team with players having indices in the vector i may be a linear function of the latent skill scores x of the individual players. In this manner, the latent skill scores may be determined as t(i)=b(i)^{T}x with b(i) as described above with respect to the two team example. In this manner, given a sample x of the latent skill scores, the ranking is such that the team with the highest latent team skill score t(i) is at the first rank, the team with the second highest team skill score is at the second rank, and the team with the smallest latent team skill score is at the lowest rank. Moreover, two teams will draw if their latent team skill scores do not differ by more than the latent tie margin ε. In this manner, the ranked teams may be re-ordered according to their value of the latent team skill scores. After re-ordering the teams based on latent team skill scores, the pairwise difference between teams may be considered to determine if the team with the higher latent team skill score is winning or if the outcome is a draw (e.g., the skill scores differ by less than c).

To determine the re-ordering of the teams based on the latent skill scores, a k−1 dimensional vector Δ of auxiliary variables may be defined where:
Δⱼ=t(i₍ⱼ₎)−−t(i₍ⱼ₊₁₎)=a^{T}ⱼx (68)
In this manner, the vector Δ may be defined as:

$$Δ = {A}^{T} x = [ \begin{matrix}{a}_{1}^{T} \\ … \\ {a}_{k + 1}^{T}\end{matrix} ] x \qquad ( 69 )$$

Since the latent skill scores x follow a Gaussian distribution (e.g., x˜N(x;s,β²I), the vector Δ is governed by a Gaussian distribution (e.g., Δ˜N(Δ;A^{T}s,β²A^{T}A). In this manner, the probability of the ranking r (encoded by the matrix A based on the permutation operator ( ) and the k−1 dimensional vector y) can be expressed by the joint probability over Δ as:

$$P ( y \vert {s}_{{i}_{1}} , … , {s}_{{i}_{k}} ) = {\prod }_{j = 1}^{k} {( P ( {Δ}_{j} > ɛ ) )}^{{y}_{j}} {( P ( \vert {Δ}_{j} \vert \leq ɛ ) )}^{1 - {y}_{j}} \qquad ( 70 )$$

The belief in the skill score of each player (P(sᵢ)) which is parameterized by the mean skill scores μ and variances σ² may be updated given the outcome of the game in the form of a ranking r. The belief may be determined using assumed density filtering with standard numerical integration methods (for example, Gentz, et al., Numerical Computation of Multivariate Normal Probabilities, Journal of Computational and Graphical Statistics 1, 1992, pp. 141-149.), the expectation propagation technique (see below), and any other suitable technique. In the special case that there are two teams (e.g., k=2), the update equations reduce to the algorithms described above in the two team example. And similarly, if each of the two teams has only one player, the multiple team equations reduce to the algorithms described above in the two player example.

In this example, the update algorithms for the skill scores of players of a multiple team game may be determined with a numerical integration for Gaussian integrals. Similarly, the dynamic update of the skill scores based on time since the last play time of a player may be a constant To for non-play times greater than 0, and 0 for a time delay between games of 0 or at the first time that a player plays the game.

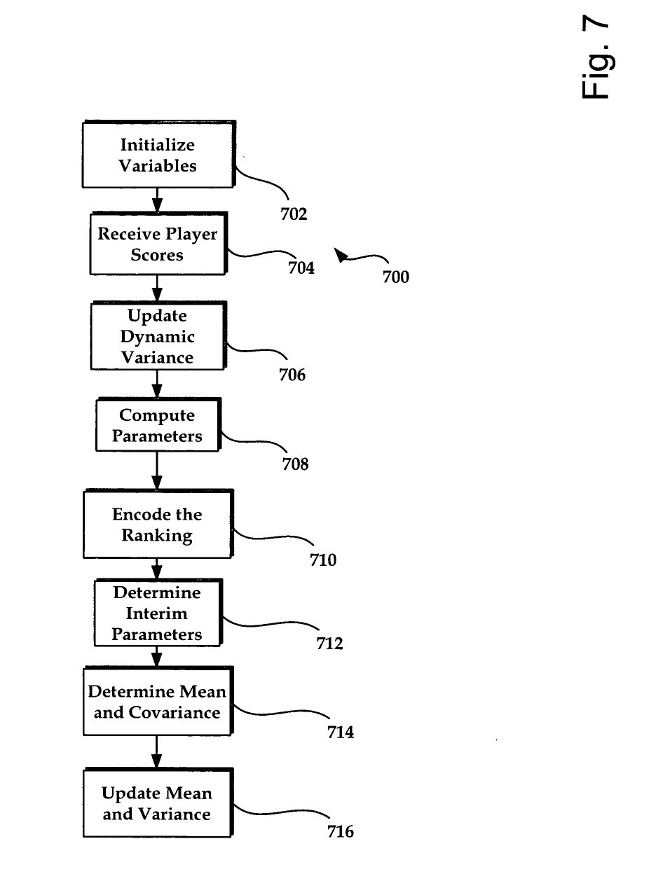

FIG. 7 illustrates an example method 700 of updating the skill scores of players playing a multiple team game. The latent tie zone ε, the dynamic time update constant τ₀, and the latent skill score variations may be initialized 702 as noted above. In addition, the matrix A having k−1 columns and n rows (i.e., the total number of players in all teams) may be initialized 702 with any suitable set of numbers, such as 0. The skill score sᵢ (e.g., represented by the mean μᵢ and variance σᵢ²) may be received 704 for each of the players i in each of the teams, which in the multiple team example includes mean μⱼ_{ᵢ} and variance σⱼ²_{ᵢ} for each player i in each team j.

Since the dynamic update to the belief may be based on time, the dynamic update may depend on the variance of that player (and possibly the time since that player last played). Thus, the variance of each player may be updated 706 using equation (31) above. In this manner, for each player in each team, the dynamic update to the variance may be determined before the game outcome is evaluated. More particularly, the update to the variance based on time since the player last played the game, and the player's skill may have changed in that period of time before the current game outcome is evaluation. Alternatively, the dynamic update may be done at any suitable time, such as after the game outcome and before the skill score update, after the skill scores are updated based on the game outcome, etc.

The skill scores may be rank ordered by computing 708 the permutation ( ) according to the ranks r of the players participating in the game. For example, the ranks may be placed in decreasing rank order.

The ranking r may be encoded 710 by the matrix A. More particularly, for each combination of the n₍ⱼ₎ and n₍ⱼ₊₁₎ players of team (j) and (j+1), the matrix element A_{row,j} may be determined as:

$${A}_{row , j} = \frac{2}{{n}_{( j )} + {n}_{( j + 1 )}} \qquad ( 71 )$$

where the row variable runs over the indices iⱼ of all the players in team j, the column variable is defined by the index j which varies from 1 to k−1 (where k is the number of teams), and

$${A}_{row + 1 j} = \frac{- 2}{{n}_{( j )} + {n}_{( j + 1 )}} \qquad ( 72 )$$

where the row variable runs over the indices i₍ⱼ₊₁₎, of all the players in team (j+1), the column variable is defined by the index j which varies from 1 to k−1 (where k is the number of teams), nⱼ is the number of players on the jth team, and n₍ⱼ₊₁₎ is the number of players on the (j+1)th team. Note also that the team indices are assumed to be in the outcome order (i.e., team 1 won over team 2, etc.).

For example, teams may play a game and be identified by Team A, Team B, and Team C, with each team having two payers identified by Player A1, Player A2, Player B1, Player B2, Player C1, and Player C2. After the game, Team A may win over both Teams B and C, and Team B may win over Team C. An example ranking matrix (matrix A) of the players is shown by matrix 1100 of FIG. 11. Specifically, the ranking matrix 1100 has two columns 1102, 1104 defined by the index j which varies from 1 to 2 (i.e., 1 to k−1 where k is the number of teams which in the illustrated example is three). The ranking matrix 1100 has six rows 1106, 1108, 1110, 1112, 1114, 1116 representing each of the two players in each of the three teams, i.e., Player A1, Player A2, Player B1, Player B2, Player C1, and Player C2 respectively. The player rankings for Players A1 and A2 are encoded in the ranking matrix 1100 at matrix elements 1120, 1122, 1124, 1126. Specifically, the player rankings of Players A1 and A2 at matrix elements 1120, 1124 in column 1102 are determined using Equation (71) above as

$$\frac{2}{{n}_{A} + {n}_{B}} = \frac{2}{2 + 2} = \frac{1}{2}$$

since each of Team A and Team B has two players. The player rankings of Players A1 and A2 at matrix elements 1122, 1126 in column 1104 are determined as zero. The player rankings for Players B1 and B2 are encoded in the ranking matrix 1100 at matrix elements 1128, 1130, 1132, 1134. Specifically, the player rankings of Players B1 and B2 at matrix elements 1128, 1132 in column 1102 are determined using Equation (72) above as

$$\frac{- 2}{{n}_{A} + {n}_{B}} = \frac{- 2}{2 + 2} = - \frac{1}{2}$$

since each of Team A and Team B has two players. The player rankings of Players B1 and B2 at matrix elements 1130, 1134 in column 1104 are determined using Equation (71) above as

$$\frac{2}{{n}_{B} + {n}_{C}} = \frac{2}{2 + 2} = \frac{1}{2}$$

since each of Team B and Team C has two players. The player rankings of Players C1 and C2 are encoded in the ranking matrix 1100 at matrix elements 1136, 1138, 1140, 1142. Specifically, the player rankings of Players C1 and C2 at matrix elements 1136, 1140 in column 1102 are determined as zero. The player rankings of Players C1 and C2 at matrix elements 1138, 1142 in column 1104 are determined using Equation (72) above as

$$\frac{- 2}{{n}_{B} + {n}_{C}} = \frac{- 2}{2 + 2} = - \frac{1}{2}$$

since each of Team B and Team C has two players.

In some cases, one or more players may enter a game late, leave a game early for any number of reasons such as connection is broken, late entry, leave game because not like the outcome, leave game due to interest, entry and exit determined on third party such as a coach, and the like. Thus, in some cases, the partial time to play the game leading to the game outcome may be used to weight the rankings. In this manner, if one team has a player drop out, then the remaining players of that team may not be penalized for losing the game, since that would be an expected outcome. Conversely, the remaining players of a team may receive an extra benefit or skill update if they win the game since that would be an unexpected outcome, e.g., a 3 player team wins against a 4 player team.

To implement partial play into the ranking matrix A, the ranking may be weighted based on an average team size. Specifically, in one example, the fractional time played in a game pⱼ_{ₖ} (of player k of team j) may be determined for each player participating in the game. The fractional time played pⱼ_{ₖ} for each player k of team j may be determined using:

$${p}_{{j}_{k}} = \frac{time that player k of team j plays game}{total time of game} \qquad ( 72.1 )$$

The ranking matrix A may be updated for the team (j) using:

$${A}_{row , j} = \frac{2 {p}_{{( j )}_{row}}}{{\sum }_{k = 1}^{{n}_{( j )}} {p}_{{( j )}_{k}} + {\sum }_{k = 1}^{{n}_{( j + 1 )}} {p}_{{( j + 1 )}_{k}}} \qquad ( 72.2 )$$

where the fraction time played p₍ⱼ₎_{_{row}} is the fraction time played of the player associated with the row of A_{row,j}. The summations in the denominator of Equation (72.2) indicate the sum of the fraction of time played by all players of each of the teams (j) and (j+1). In a similar manner, the ranking matrix may be updated for the losing team (1+1) using:

$${A}_{row , j + 1} = \frac{- 2 {p}_{{( j + 1 )}_{row}}}{{\sum }_{k = 1}^{{n}_{( j )}} {p}_{{( j )}_{k}} + {\sum }_{k = 1}^{{n}_{( j + 1 )}} {p}_{{( j + 1 )}_{k}}} \qquad ( 72.3 )$$

where the fraction time played P₍ⱼ₊₁₎_{_{row}} is the fraction time played of the player associated with the row of A_{row,j+1}. The summations in the denominator of Equation (72.3) indicate the sum of the fraction of time played by all players of each of the teams (i) and (i+1).

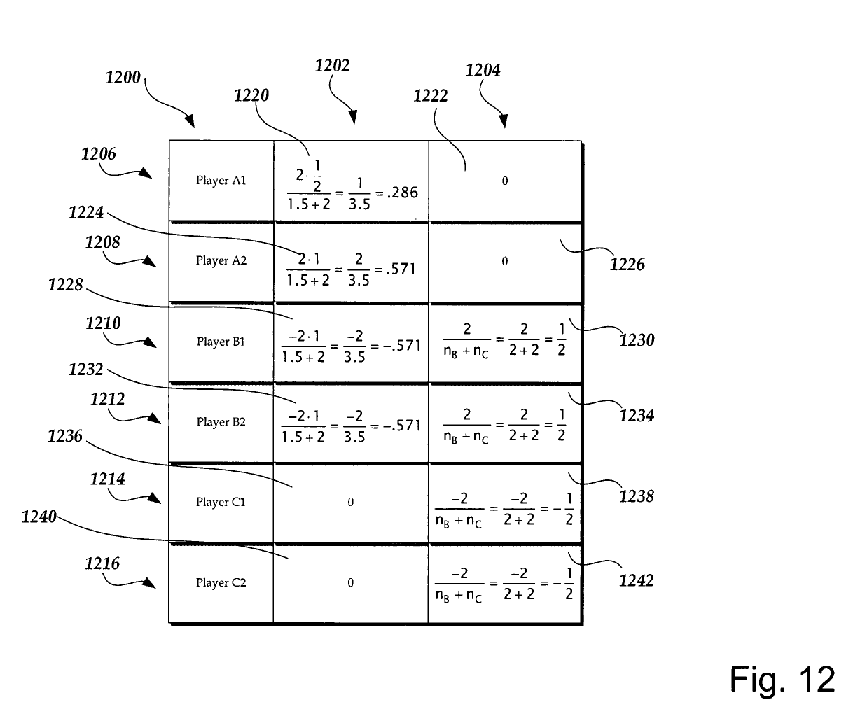

For example, teams may play a game and be identified by Team A, Team B, and Team C, with each team having two payers identified by Player A1, Player A2, Player B1, Player B2, Player C1, and Player C2. However, player A1 may play only half of the time. After the game, despite the partial play of Player A1, Team A may win over both Teams B and C, and Team B may win over Team C. An example ranking matrix (matrix A) of the players is shown by matrix 1200 of FIG. 12. Specifically, the ranking matrix 1200 has two columns 1202, 1204 defined by the index j which varies from 1 to 2 (i.e., 1 to k−1 where k is the number of teams which in the illustrated example is three). The ranking matrix 1200 has six rows 1206, 1208, 1210, 1212, 1214, 1216 representing each of the two players in each of the three teams, i.e., Player A1, Player A2, Player B1, Player B2, Player C1, and Player C2 respectively. The player rankings for Players A1 and A2 are encoded in the ranking matrix 1200 at matrix elements 1220, 1222, 1224, 1226. Specifically, the player rankings of Players A1 and A2 at matrix elements 1220, 1224 in column 1202 are determined using Equation (72.2) above. The player rankings of Players A1 and A2 at matrix elements 1222, 1226 in column 1204 are determined as zero. The player rankings for Players B1 and B2 are encoded in the ranking matrix 1200 at matrix elements 1228, 1230, 1232, 1234. Specifically, the player rankings of Players B1 and B2 at matrix elements 1228, 1232 in column 1202 are determined using Equation (72.3) above. The player rankings of Players B1 and B2 at matrix elements 1130, 1134 in column 1104 are determined using Equation (71) since none of the players of teams B and C included partial play. The player rankings of Players C1 and C2 are encoded in the ranking matrix 1200 at matrix elements 1236, 1238, 1240, 1242 as with the ranking matrix 1100 of FIG. 11 since none of the players of Teams B and C had partial play.

In some cases, the exact ranking of teams may not available based on the outcome of the game, e.g., the rankings of all teams based on the game outcome may be partial. For example, in some cases, only the ending skill score of a portion of the teams may be known or determined relative to other teams such as in a racing game where a team crossing a finish line may trigger a timer and the race results may only be able to rank the teams crossing the finish line within the predetermined time after the winner has crossed the finish line.

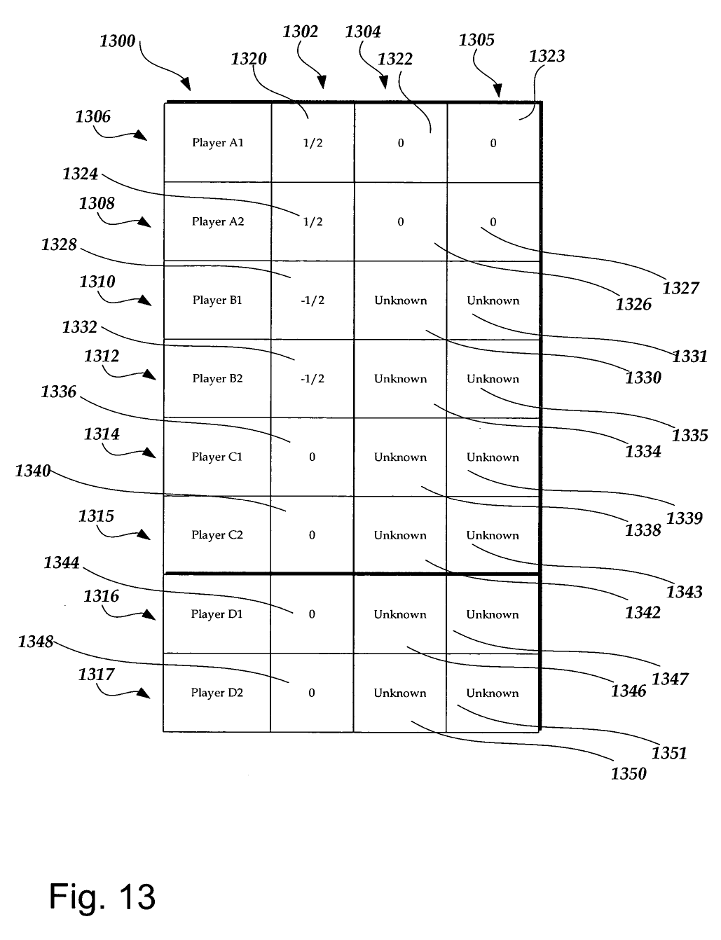

To illustrate this, in one example, after a game, the relative ranking of Teams C and D may be unknown. Based on the skill scores and results, it may be determined that Team A won over Teams B, C, and D (based on Team B's skill score and the lack of skill score for Teams C and D), and similarly, that Team B won over Teams C and D based on Team B's skill score and the lack of skill score for Teams C and D. However, the relative ranking of Teams C and D is unknown based on the game outcome. Specifically, FIG. 13 illustrates the ranking matrix A of partial rankings with the unknown rankings of Teams C and D. The ranking matrix 1300 of FIG. 13 has three columns 1302, 1304, 1305 defined by the index j which varies from 1 to 3 (i.e., 1 to k−1 where k is the number of teams which in the illustrated example is four). The ranking matrix 1300 has eight rows 1306, 1308, 1310, 1312, 1314, 1315, 1316, 1317 representing each of the two players in each of the four teams, i.e., Player A1, Player A2, Player B1, Player B2, Player C1, Player C2, Player D1, and Player D2 respectively. The player rankings for Players A1 and A2 are encoded in the ranking matrix 1300 at matrix elements 1320, 1322, 1323, 1324, 1326, 1327 similarly to that as in the ranking matrix 1100 of FIG. 1100. The player rankings for Players B1 and B2 are encoded in the ranking matrix 1300 at matrix elements 1328, 1330, 1331, 1332, 1334, 1335. Specifically, the player rankings of Players B1 and B2 at matrix elements 1328, 1332 in column 1302 are determined similarly to that as in ranking matrix 1100 of FIG. 11 in comparing Team A to Team B. However, the player rankings of Players B1 and B2 at matrix elements 1330, 1334 in column 1304 and matrix elements 1331, 1335 in column 1305 are unknown since the relative rankings of Teams C and D to Team B are unknown. The player rankings of Players C1 and C2 are encoded in the ranking matrix 1300 at matrix elements 1336, 1338, 1339, 1340, 1342, 1343 and are unknown. The player rankings of Players D1 and D2 are encoded in the ranking matrix 1300 at matrix elements 1344, 1346, 1347, 1348, 1350, 1351 are unknown.

As noted above in constructing the ranking matrix A, the (j)th ranking team is compared to the (j+1)th ranking team. However, as shown in the example ranking matrix of FIG. 13, in the case of Team C, it is unknown whether Team C should be compared to Team B or Team D, and similarly for Team D, it is unknown whether Team D should be compared to Team B or Team C since their exact ranking is unknown. To allow a determination of the ranking matrix in view of partial rankings, the ranking matrix A may be constructed by comparing the (j+1)th team, not with the (j)th team as discussed above with respect to Equations (71) and (72), but rather, with the last team that has a known ranking.

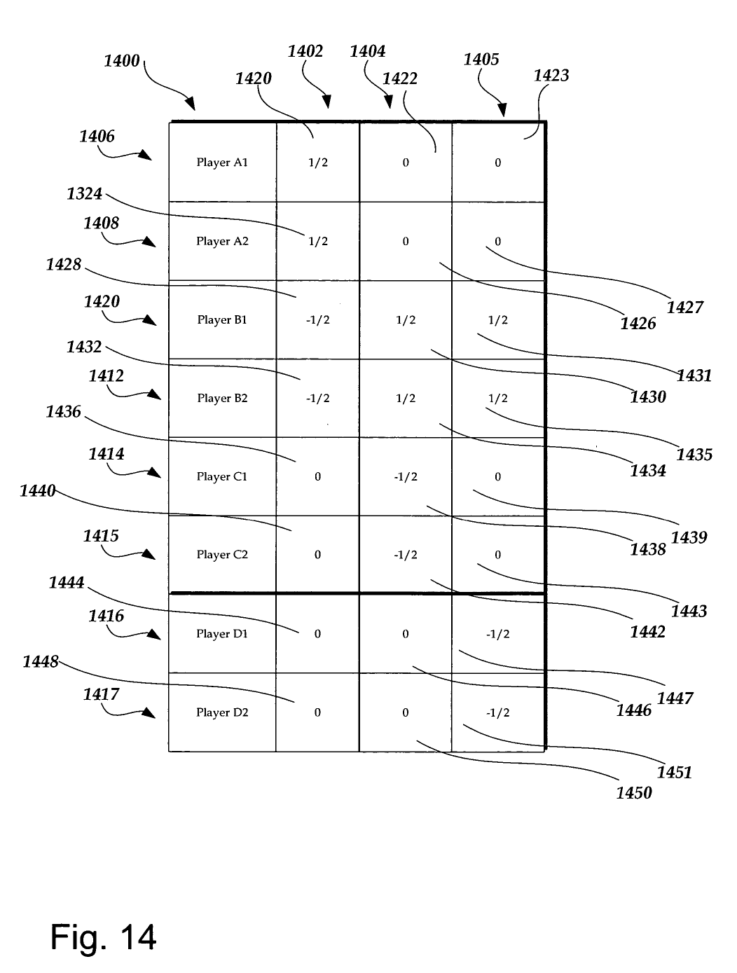

The example ranking matrix 1400 of FIG. 1400 illustrates a complete ranking matrix with partial input rankings by comparing Team C with Team B, and Team D with Team B. Specifically, the ranking matrix 1400 of FIG. 14 has three columns 1402, 1404, 1405 defined by the index j which varies from 1 to 3 (i.e., 1 to k=1 where k is the number of teams which in the illustrated example is four). The ranking matrix 1400 has eight rows 1406, 1408, 1410, 1412, 1414, 1415, 1416, 1417 representing each of the two players in each of the four teams, i.e., Player A1, Player A2, Player B1, Player B2, Player C1, Player C2, Player D1, and Player D2 respectively. The player rankings for Players A1 and A2 are encoded in the ranking matrix 1400 at matrix elements 1420, 1422, 1423, 1424, 1426, 1427 similarly to that as in the ranking matrix 1300 of FIG. 1300. The player rankings for Players B1 and B2 are encoded in the ranking matrix 1400 at matrix elements 1428, 1430, 1431, 1432, 1434, 1435. Specifically, the player rankings of Players B1 and B2 at matrix elements 1428, 1432 in column 1402 are determined similarly to that as in ranking matrix 1300 of FIG. 13 in comparing Team A to Team B. The player rankings of Players B1 and B2 at matrix elements 1430, 1434 in column 1404 are determined by comparing Team B to Team C using Equation (71) above similar to that as discussed above in ranking matrix 1100 of FIG. 11. Similarly, the player rankings of Players B1 and B2 at matrix elements 1431, 1435 in column 1405 are determined by comparing Team B to Team D using Equation (71) above similar to that as discussed above in ranking matrix 1100 of FIG. 11. The player rankings of Players C1 and C2 are encoded in the ranking matrix 1400 at matrix elements 1436, 1438, 1439, 1440, 1442, 1443 comparing Team C to the last known ranked team (i.e., Team B) and using Equation (72) above. The player rankings of Players D1 and D2 are encoded in the ranking matrix 1400 at matrix elements 1444, 1446, 1447, 1448, 1450, 1451 comparing Team D to the last known ranked team (i.e., Team B) and using Equation (72) above. Although the partial ranking example is discussed with respect to all players playing a full time, it is to be appreciated that partial play using Equations (72.3) and (72.4) may be used to incorporate partial play with partial rankings.

If the jth team is of the same rank as the (j+1) team, then the lower and upper limits a and b of a truncated Gaussian may be set as:
aᵢ=−ε (73)
bᵢ=∞ (74)

Otherwise, if the jth team is not of the same rank as the (j+1) team, then the lower and upper limits a and b of a truncated Gaussian may be set as:
aᵢ=ε (75)
bᵢ=∞ (76)

The determined matrix A may be used to determine 712 interim parameters. Interim parameters may include a vector μ and matrix C using the equations:
u=A^{T}μ (77)
C=A^{T}(β²I+diag(σ²))A (78)
where the vector μ is a vector containing the means of the layers, β is the latent skill score variation, and μ is a vector containing the variances of the players. The vector μ and σ² may contain the means of the participating players or of all the players. If the vector contains the skill score parameters for all the players, then, the construction of A may provide a coefficient of zero for each non-participating player.

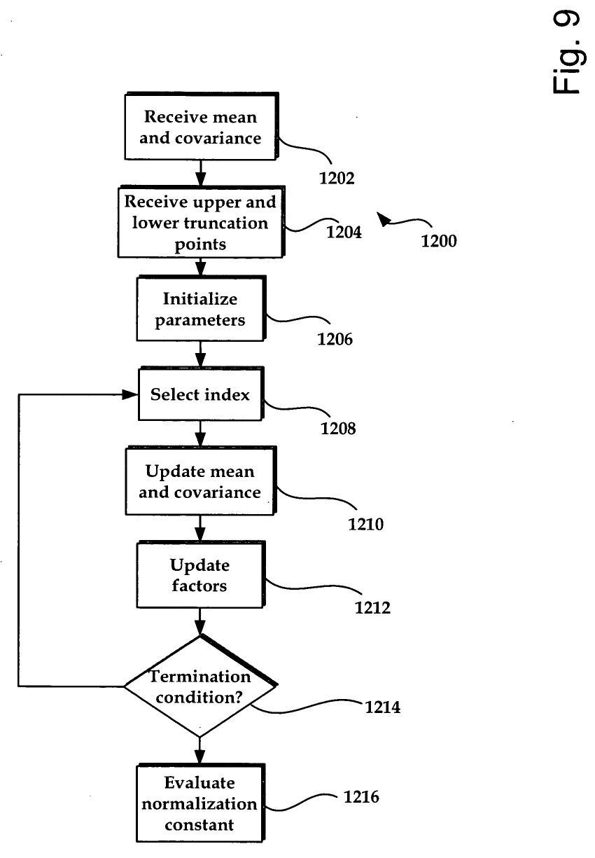

The interim parameters μ and C may be used to determine 714 the mean z and the covariance Z of a truncated Gaussian representing the posterior with parameters μ, C, and integration limits of the vectors a and b. The mean and covariance of a truncated Gaussian may be determined using any suitable method including numerical approximation (see Gentz, et al., Numerical Computation of Multivariate Normal Probabilities, Journal of Computational and Graphical Statistics 1, 1992, pp. 141-149.), expectation propagation (see below), and the like. Expectation Propagation will be discussed further below with respect to FIG. 9.

Using the computed mean z and covariance Z, the skill score defined by the mean μᵢ and the variance σ² of each player participating in the multi-team game may be updated 716. In one example, the function vector v and matrix W may be determined using:
v=AC⁻¹(z−u) (79)
W=AC⁻¹(C−Z)C⁻¹A^{T} (80)
Using the vector v and the matrix W, the mean μⱼ_{ᵢ} and variance σ²ⱼ_{ᵢ} of each player i in each team j may be updated using:
μⱼ_{ᵢ}←μⱼ_{ᵢ}+σ²ⱼ_{ᵢ}vⱼ_{ᵢ} (81)
σ²ⱼ_{ᵢ}←σ²ⱼ_{ᵢ}(1−σ²ⱼ_{ᵢ}Wⱼ_{ᵢ}ⱼ_{ᵢ}) (82)
The above equations and methods for a multiple team game may be reduced to the two team and the two player examples given above.

In this manner, the update to the mean of each player's skill score may be a linear increase or decrease based on the outcome of the game. For example, if in a two player example, player A has a mean greater than the mean of player B, then player A should be penalized and similarly, player B should be rewarded. The update to the variance of each player's skill score is multiplicative. For example, if the outcome is unexpected, e.g., player A's mean is greater than player B's mean and player A loses the game, then the variance of each player may be reduced more because the game outcome is very informative with respect to the current belief about the skill scores. Similarly, if the players' means are approximately equal (e.g., their difference is within the latent tie margin) and the game results in a draw, then the variance may be little changed by the update since the outcome was to be expected.

As discussed above, the skill scores represented by the mean μ and variance a σ² for each player may be used to predict the probability of a particular game outcome y given the mean skill scores and standard deviations of the skill scores for all participating players. The predicted game outcome may be used to match players for future games, such as by comparing the predicted probability of the outcome of the potential game with a predetermined threshold, player indicated preferences, ensuring an approximately equal distribution over possible outcomes (e.g., within 1-25%), and the like. The approximately equal distribution over the possible outcomes may depend on the number of teams playing the game. For example, with two teams, the match may be set if each team has an approximately 50% chance of winning or drawing. If the game has 3 teams, then the match may be made if each opposing team has an approximately 30% chance of winning or drawing. It is to be appreciated that the approximately equal distribution may be determined from the inverse of number of teams playing the game.

In one example, one or more players matched by the player match module may be given an opportunity to accept or reject a match. The player's decision may be based on given information such as the challenger's skill score and/or the determined probability of the possible outcomes. In another example, a player may be directly challenged by another player. The challenged player may accept or deny the challenge match based on information provided by the player match module.

The probability of a game outcome may be determined from the probability of the outcome given the skill scores P(y|sᵢ_{ₗ}, . . . ,sᵢ_{ₖ}), where the attained knowledge over the skill scores sᵢ_{ₗ}, . . . , Sᵢ_{ₖ} represented by the mean and variance of each player is marginalized out.

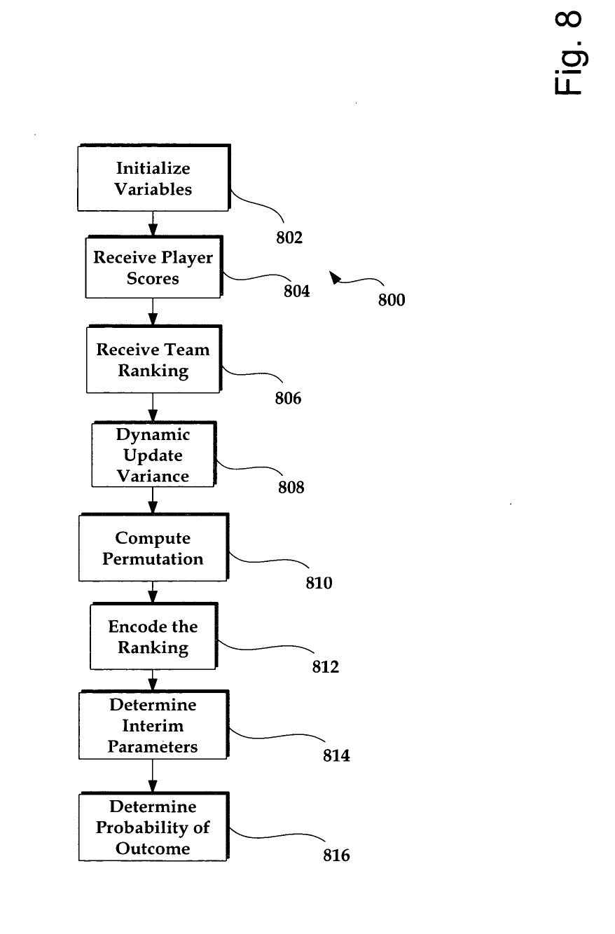

Like the skill scoring update equations above, the matching method of FIG. 6 may be modified to accommodate multiple teams of one or more players each. An example modified method 800 of determining the probability of an outcome is shown in FIG. 8. Like above, the static variables, such as the latent skill score variation β, the latent tie zone ε, the constant dynamic τ₀, and the matrix A, may be initialized 802. The matrix A may be initialized to a matrix containing all zeros.

The skill score sᵢ (represented by the mean μᵢ and the variance σᵢ² for each participating player i) may be received 804 for each of the players. The ranking r of the k teams may be received 806. For each player participating, the variance σᵢ² may be updated 808 for each participating player based upon the time since that player has last played the game, e.g., dynamic update based on time. In this manner, the variance for each potential participating player i, the variance may be updated using equation (31) above.

The skill scores of the teams may be rank ordered by computing 810 the permutation ( ) according to the ranks r of the players. For example, as noted above, the ranks may be placed in decreasing rank order.

The encoding of the ranking may be determined 812. The encoding of the ranking may be determined using the method described with reference to determining the encoding of a ranking 710 of FIG. 7 and using equations (71-76). Interim parameters u and C may be determined 814 using equations (77-78) above and described with reference to determining interim parameters 712 of FIG. 7. To incorporate the dynamic update into a prediction of a game outcome some time Δt>0 since the last update, an extra summand of (n₍ⱼ₎+n₍ⱼ₊₁₎)τ₀ may be added to the jth diagonal element of matrix C of equation (78) above.

The probability of the game outcome may be determined 816 by evaluation of the value of the constant function of a truncated Gaussian with mean u and variance C. As noted above, the truncated Gaussian may be evaluated in any suitable manner, including numerical approximation (see Gentz, et al., Numerical Computation of Multivariate Normal Probabilities, Journal of Computational and Graphical Statistics 1, 1992, pp. 141-149.), expectation propagation, and the like.

Numerical Approximation

One suitable technique of numerical approximation is discussed in Gentz, et al., Numerical Computation of Multivariate Normal Probabilities, Journal of Computational and Graphical Statistics 1, 1992, pp. 141-149. In one example, if the dimensionality (e.g., the number of players nⱼ in a team j) of the truncated Gaussian is small, then the approximated posterior may be estimated based on uniform random deviates, based on a transformation of random variables which can be done iteratively using the cumulative Gaussian distribution Φ discussed above.

Since the normalization constant Zᵣ(u,C) equals the probability of the ranking r, then the normalization constant may be determined by integrating the equation:

$${z}_{r} ( μ , σ ) = {\int }_{a}^{b} N ( z ; u , C ) ⅆ z \qquad ( 83 )$$

The mean z may be determined using ADF by:

$${〈 z 〉}_{z ∼ R ( z )} = u ( μ ) + \sqrt{C} [ v ( \frac{u ( μ )}{\sqrt{C}} \frac{ɛ}{\sqrt{C}} ) \cdot {\tilde{v} ( \frac{u ( μ )}{\sqrt{C}} \frac{ɛ}{\sqrt{C}} )}^{1 - y} ] \qquad ( 84 )$$

Numerically approximating the above equations will provide the mean and normalization constant which may be used to numerically approximate a truncated Gaussian.

Expectation Propagation

Rather than numerical approximation, expectation propagation may be used to update and/or predict the skill score of a player. In the case of multiple teams, the update and prediction methods may be based on an iteration scheme of the two team update and prediction methods. To reduce the number of inversion s calculated during the expectation propagation, the Gaussian distribution may be assumed to be rank 1 Gaussian, e.g., that the likelihood t_{i,r} is some function of the one-dimensional projection of the skill scores s. The efficiency over the general expectation approximation may be increased by assuming that the posterior is a rectified, truncated Gaussian distribution.

For example, FIG. 9 shows an example method 1200 of approximating a truncated Gaussian with expectation propagation.

The mean μ and covariance Σ of a non-truncated Gaussian may be received 1202. The mean may have n elements, and the covariance matrix may be dimensioned as n×n. The upper and lower truncation points of the truncated Gaussian may be received. For example, if the jth team is of the same rank as the j+1 team, then the lower and upper limits a and b of a truncated Gaussian may be set for each j and j+1 player as:
a=−ε (85)
bᵢ=ε (86)
Otherwise, if the jth team is not of the same rank as the j+1 team, then the variables a and b may be set for each j and j+1 player as:
aᵢ=ε (87)
bᵢ=∞ (87.1)

The parameters of the expectation propagation may be initialized 1206. More particularly, for each i from 1 to n, the mean μᵢ may be initialized to zero or any other suitable value, the parameter πᵢ may be initialized to zero or any other suitable value, the parameter ζᵢ may be initialized to 1 or any other suitable value. The approximated mean μ* may be initialized to the received mean μ, and the approximated covariance Σ* may be initialized to the received covariance Σ.

An index j may be selected 1208 from 1 to n. The approximate mean and covariance (μ* and Σ*) may be updated 1210. More particularly, the approximate mean and covariance may be updated by:

$$\begin{matrix}{μ}^{*} = {μ}^{*} + \frac{{π}_{j} ( {μ}_{j}^{*} - {μ}_{j} ) + {α}_{j}}{{e}_{j}} {t}_{j} & ( 88 ) \\ {Σ}^{*} = {Σ}^{*} + \frac{{π}_{j} {e}_{j} - {β}_{j}}{{e}_{j}^{2}} {t}_{j} {t}_{j}^{T} & ( 89 )\end{matrix}$$

where tⱼ is determined by:
t_{J}=[Σ*_{1,j},Σ*_{2,j}, . . . ,Σ*_{n,j}] (90)
and the factors dⱼ and eⱼ are determined by:
dⱼ=πᵢΣ*_{j,j} (91)
eⱼ=1−dⱼ (92)
The factors αⱼ and βⱼ may be determined by:

$$\begin{matrix}{α}_{j} = \frac{v ( {φ}_{j}^{′} , {a}_{j}^{′} , {b}_{j}^{′} )}{\sqrt{{ψ}_{j}}} & ( 93 ) \\ {β}_{j} = \frac{w ( {φ}_{j}^{′} , {a}_{j}^{′} , {b}_{j}^{′} )}{{ψ}_{j}} & ( 94 )\end{matrix}$$

where the function v( ) and w( ) may be evaluated using equations (17-18) above and the parameters φ′ⱼ, a′ⱼ, b′ⱼ, and ψⱼ may be evaluated using:

$$\begin{matrix}{φ}_{j} = {μ}_{j}^{*} + \frac{{d}_{j} ( {μ}_{j}^{*} - {μ}_{j} )}{{e}_{j}} & ( 95 ) \\ {ψ}_{j} = \frac{{Σ}_{j , j}^{*}}{{e}_{j}} & ( 96 ) \\ {φ}_{j}^{′} = \frac{{φ}_{j}}{\sqrt{{ψ}_{j}}} & ( 97 ) \\ {ψ}_{j}^{′} = \frac{{ψ}_{j}}{\sqrt{{ψ}_{j}}} & ( 98 ) \\ {a}_{j}^{′} = \frac{{a}_{j}}{\sqrt{{ψ}_{j}}} & ( 99 ) \\ {b}_{j}^{′} = \frac{{b}_{j}}{\sqrt{{ψ}_{j}}} & ( 100 )\end{matrix}$$

The factors πⱼ, μⱼ, and ζⱼ may be updated 1212. More particularly, the factors may be updated using:

$$\begin{matrix}{π}_{j} = \frac{1}{( {β}_{j}^{- 1} - {ψ}_{j} )} & ( 101 ) \\ {μ}_{j} = {φ}_{j} + \frac{{α}_{j}}{{β}_{j}} & ( 102 ) \\ {c}_{j} = ( Φ ( {b}_{j}^{′} - {φ}_{j}^{′} ) - Φ ( {a}_{j}^{′} - {φ}_{j}^{′} ) ) exp \frac{{α}_{j}^{2}}{2 {β}_{j} \sqrt{1 - {ψ}_{j} {β}_{j}}} & ( 103 )\end{matrix}$$

The termination criterion may then be evaluated 1214. For example, the termination condition Δ_{z} may be computed using:
Δ_{z}=|Z*−Z*_{old} (104)
or any other suitable termination condition which may indicate convergence of the approximation. The determined termination condition Δ_{z} may be compared to a predetermined termination toleration criterion δ. If the absolute value of the determined termination condition is less than or equal to the termination toleration criterion, then the approximated mean μ*, variance Σ*, and normalization constant Z* may be considered converged. If the termination criterion is not fulfilled, then the method may return to selecting an index 1208. If the termination criterion is fulfilled, then the approximated mean and covariance may be returned. In addition, the normalization constant Z* may be evaluated 1216. More particularly, the normalization constant may be evaluated using:

$${Z}^{*} = ( {\prod }_{i = 1}^{n} {ζ}_{i} ) \cdot \sqrt{\vert Σ * {Σ}^{- 1} \vert} \cdot exp ( - \frac{1}{2} ( {\sum }_{i = 1}^{n} {π}_{i} {μ}_{i}^{2} + {μ}^{T} {Σ}^{- 1} μ - {μ}^{* T} {Σ}^{* - 1} {μ}^{*} ) ) \qquad ( 105 )$$

Matchmaking and Leaderboards

As noted above, the probability of the outcome may be used to match players such that the outcome is likely to be challenging to the teams, in accordance with a predetermined threshold. Determining the predicted outcome of a game may be expensive in some cases in terms of memory to store the entire outcome distribution for more than four teams. More particularly, there are O(2^{k-1}k!) outcomes where k is the number of teams and where O( ) means ‘order of’, e.g., the function represented by O( ) can only be different by a scaling factor and/or a constant. In addition, the predicted outcomes may not distinguish between players with different standard deviations σᵢ if their means uh are identical. In some cases, it may be computationally expensive to compute the distance between two outcome distributions. Thus, in some cases it may be useful to compute the skill score gap between the skill scores of two players. For example, the skill score gap may be defined as the difference between two skill scores sᵢ and sⱼ. The expected skill score gap E(sᵢ−sⱼ) or E[(sᵢ−sⱼ)²] may be determined using:

$$E [ \vert {s}_{i} - {s}_{j} \vert ] = 2 {σ}_{ij}^{2} N ( {μ}_{ij} ; 0 , {σ}_{ij}^{2} ) + {μ}_{ij} ( 2 Φ ( \frac{{μ}_{ij}}{{σ}_{ij}} ) - 1 ) \qquad ( 106 )$$

or
E└(sᵢ−sⱼ)²┘=μ²ᵢⱼ+σ²ᵢⱼ (107)
where μᵢⱼ is the difference in the means of the players (i.e., μᵢⱼ=μᵢ−μⱼ) and where σᵢⱼ² is the sum of the variances of the players i and j (i.e., σᵢⱼ²=σⱼ²+σⱼ²). The expectation of the gap in skill scores may be compared to a predetermined threshold to determine if the player i and j should be matched. For example, the predetermined threshold may be in the range of approximate 3 to approximately 6, and may depend on many factors including the number of players available for matching. More particularly, the more available players, the lower the threshold may be set.

Moreover, the skill score belief of player i can be used to compute a conservative skill score estimate as uᵢ−lσⱼ where l is a positive number that quantifies the level of conservatism. Any appropriate number for 1 may be selected to indicate the level of conservatism, such as the number 3, may be used for leaderboards. In many cases, the value of the factor l may be positive, although negative numbers may be used in some cases such as when determining ‘optimistic’ skill score estimate. An advantage of such a conservative skill score estimate is that for new players, the estimate it can be zero (due to the large initial variance σᵢ²) which is often more intuitive for new players (“starting at zero”).

Convergence of the Skill Score

The mean μᵢ of a player may not converge on a particular value since it may depend on the true (unknown) probabilities of winning between all players. On the other hand, the variance σᵢ may converge on a fixed point because every incorporation of data such as game outcomes may decrease the entropy of the skill belief.

Matching

As noted above, two or more players in a team and/or two or more teams may be matched for a particular game in accordance with some user defined and/or predetermined preference, e.g., probability of drawing, and the like. In some examples, a good or preferable match may be defined as a match where each player could win the game. Specifically, a match may be desirable if the probability that all participating teams will draw is approximately large.

To determine the probability of a draw to measure if the match is desirable, the dependence on the draw margin E may be removed by considering the limit as ε→0. If the current skill beliefs of the players are given by the vector of means μ and the vector of covariances Σ then the probability of a draw given the mean and covariances (P(draw|μ, Σ) may be determined as:

$$\begin{matrix}P ( draw \vert μ , Σ ) = {lim}_{ɛ \to 0} \int N ( z ; {A}^{T} μ ; {A}^{T} ( {β}^{2} I + Σ ) A ) ⅆ z \\ = N ( 0 ; {A}^{T} μ ; {A}^{T} ( {β}^{2} I + Σ ) A\end{matrix} \qquad ( 108 )$$

where the matrix A is determined for the match as noted above in equations (71) and (72).

The draw probability given the skill scores of equation (108) may be compared to any suitable match quality measure, which may be predetermined in the match module and/or provided by the user. In one example, the match quality measure may be the draw probability of the same match where all teams have the same skill, i.e., A^{T}μ=0, and there is no uncertainty in the player skills. In this manner, the match quality measure q_{draw}(μ, Σ,β,A) may be determined as:

$$\begin{matrix}{q}_{draw} ( μ , Σ , β , A ) = \frac{N ( 0 ; {A}^{T} μ ; {A}^{T} ( {β}^{2} I + Σ ) A )}{N ( 0 ; 0 ; {β}^{2} {A}^{T} A )} \\ = exp ( - \frac{1}{2} {μ}^{T} {A ( {β}^{2} {A}^{T} A + {A}^{T} Σ A )}^{- 1} {A}^{T} μ ) \\ \sqrt{\frac{\vert {β}^{2} {A}^{T} A \vert}{\vert {β}^{2} {A}^{T} A + {A}^{T} Σ A \vert}}\end{matrix} \qquad ( 109 )$$

In this manner, the match quality measure may have a property such that the value of the match quality measure lies between zero and one, where a value of one indicates the best match.

If none of the players have ever played a game (e.g., their skill scores of μ, Σ have not been learned, hence μ=μ₀1, Σ=σ₀²I, where “1” here denotes the vector of ones and “1” denotes the identity matrix), then the match quality measure for k teams may be simplified as:

$${q}_{draw} ( μ , Σ , β , A ) = exp ( - \frac{1}{2} \frac{{μ}_{0}^{2}}{( {β}^{2} + {σ}_{0}^{2} )} {1}_{i}^{T} {A ( {A}^{T} A )}^{- 1} {A}^{T} {1}_{i} ) \frac{{β}^{k}}{\sqrt{{( {β}^{2} + {σ}_{0}^{2} )}^{k}}} \qquad ( 110 )$$

If each team has the same number of players, then match quality measure of equation (110) may be further simplified as:

$${q}_{draw} ( μ , Σ , β , A ) = \frac{{β}^{k}}{\sqrt{{( {β}^{2} + {σ}_{0}^{2} )}^{k}}} \qquad ( 111 )$$

An example method of determining and using the match quality measure is described with reference to the method 800 of FIG. 8. The parameters may be initialized 802. For example, the performance variance or fixed latent skill score variance 12 may be set and/or the rank encoded matrix A may be initialized to 0. The players skill scores (e.g., means μ and variances σ²=diag(Σ)) may be received 804, as noted above. The ranking r of the k teams may be received 806 in any suitable manner. For example, the ranking of the teams may be retrieved from memory.

The skill scores of the teams may be rank ordered by computing 810 the permutation ( ) according to the ranks r of the players. For example, as noted above, the ranks may be placed in decreasing rank order.

The encoding of the ranking may be determined 812. The encoding of the ranking may be determined using the method described with reference to determining the encoding of a ranking 710 of FIG. 7 and using equations (71-76). Interim parameters may be determined 814. For example, the parameters u may be determined using equations (77) above and described with reference to determining interim parameters 712 of FIG. 7. However, rather than the parameter C of equation (78), in the draw quality measure, the parameters C₁ and C₂ may be determined using:
C_{1=β}²A^{T}A (112)
C₂=C₁+A^{T}diag(σ²)A (113)

The probability of the game outcome may be determined 816 by evaluation of the value of the constant function of a truncated Gaussian with mean u and variance C. Using the draw quality measure above of equation (109), the probability of a draw may be determined as:

$${P}_{draw} = exp ( - \frac{1}{2} {u}^{T} {C}_{2}^{- 1} u ) \sqrt{\frac{\vert {C}_{1} \vert}{\vert {C}_{2} \vert}} \qquad ( 114 )$$

Two Player Match Quality

The single player, two team example is a special case of the match quality measure. As above, the first player may be denoted A and the second player may be denoted B. The match quality measure q may be written in terms of the difference between the mean skill scores of the two players and the sum of the variances of both players. Specifically, the difference in means m_{AB}=μ_{A}−μ_{B}, and the variance sum ζ_{AB}²=ζ_{A}²+ζ_{B}². In this manner, the draw quality measure may be determined using equation (109) above as:

$${q}_{draw} ( {m}_{AB} , {ς}_{AB}^{2} , β ) = exp ( - \frac{{m}_{AB}^{2}}{2 ( 2 {β}^{2} + {ς}_{AB}^{2} )} ) \sqrt{\frac{2 {β}^{2}}{2 {β}^{2} + {ς}_{AB}^{2}}} \qquad ( 115 )$$

The resulting q_{draw} from equation (115) is always in the range of 0 and 1, where 0 indicates the worst possible match and 1 the best possible match. Using equation (115), even if two players have identical means skill scores, the uncertainty in the skill scores affects the quality measure of the proposed match. For example, if either of the player's skill score uncertainties (a) is large, then the match quality criterion is significantly smaller than 1, decreasing the measure of quality of the match. This determined draw quality measure may be compared to one or more measures of expected skill differences of the players. For example, the measure of skill differences may be in the absolute or squared error sense. For example, one example of an absolute draw quality measure may be:

$$\begin{matrix}{q}_{1} ( {m}_{AB} , {ς}_{AB}^{2} , β ) = exp ( - E [ \vert {s}_{A} - {s}_{B} \vert ] ) \\ = exp ( - ( \begin{matrix}{m}_{AB} ( 2 Φ ( \frac{{m}_{AB}}{{ς}_{AB}} ) - 1 ) + \\ 2 {ς}_{AB} N ( \frac{{m}_{AB}}{{ς}_{AB}} )\end{matrix} ) )\end{matrix} \qquad ( 116 )$$

In another example, a squared error draw quality measure may be:
q₂(m_{AB},ζ²_{AB},β)=exp(−E└|s_{A}−s_{B}|²┘)=exp(−(m²_{AB}+ζ²_{AB})) (117)

It is to be appreciated that the transformation of exp(−( )) maps the expected gap in the skill score of the game to an interval of [0,1] such that 1 corresponds to a high (zero gap) quality match.

In the examples of equations (116) and (117), the quality measures may have the property that for two players of equal mean skill (i.e., m_{AB}=0), then any uncertainty in the skills of the players reduces the match quality (i.e., the value of the quality measure).

Early in the game process, e.g., one or more players or teams have skills with high uncertainty or at the initialized value of mean and variance (μ₀ and σ₀²), then the quality of a match between two prospective players may be compared against the quality threshold of q*_{draw}(0,2σ₀²,β). Specifically, the actual quality of a draw between the two players may be evaluated as described above, and may be compared to the quality threshold q*.

After the players skills have substantially converged, e.g., the players variances σ² are substantially 0, then the quality of a match between two prospective players (e.g., q_{draw}(m_{AB},0,β)) may be compared against the quality threshold of q*_{draw}(0,2σ²,β) Specifically, a match between two players may be accepted if its q_{draw} is less than the draw quality measure q*_{draw}.

The equality of q_{draw}(m_{AB},2σ²,β))=q*_{draw}(m_{AB},0,β) may be solved to determine the difference in means m_{AB} that may be needed to initially get a match accepted. For example, in the case of the match quality q_{draw}:

$$\begin{matrix}{m}_{AB} = \sqrt{2} β \sqrt{ln ( 1 + \frac{{σ}_{0}^{2}}{{β}^{2}} )} ⇔ P ( better wins ) \\ = Φ ( \sqrt{ln ( 1 + \frac{{σ}_{0}^{2}}{{β}^{2}} )} )\end{matrix} \qquad ( 118 )$$

In this manner, the probability of a better player winning is a function of

$$\frac{β}{{σ}_{0}} .$$

Example plots of the different draw quality measures of equations (115), (116) and (117) are plotted in the example graph of FIG. 10 as lines 1002, 1004, and 1006 respectively. The axis 1008 indicates the value of

$$\frac{β}{{σ}_{0}}$$

and the axis 1010 indicates the probability that the better player wins of equation (118). As can be seen in the plot 1000, the draw probability of line 1002 better indicates the actual probability of the better player winning.

In some cases, to determine a match between two players, the match module may determine the best match for a player from the available players. For example, a player may enter a gaming environment and request a match. In response to the request, the match module may determine the best match of available players, e.g., those players in the game environment that are also seeking a match. In some cases, the match module may evaluate the q_{draw} for all current players waiting for a match. Based on a critical value of the draw quality (e.g., q*_{draw}), the match module may filter out those matches that are less than the critical draw quality q*. One or more of the potential pairings of players meeting the quality measure may be presented to one or more players for acceptance or rejection, and/or the match module may set up the match in response to the determination of a ‘good enough’ match, the ‘best’ match available, the matches for all available players such that all players are matched (which may not be the ‘best’ match) and the matches meet the quality criteria. In some cases, all determined ‘good’ matches may be presented to a player, and may be, in some cases, listed in descending (or ascending) order based on the quality of the match.

However, the above approach may not scale well for large gaming environments. For example, there may be approximately one million users at any time waiting for a match. Using the actual match quality measure q_{draw} may require the match module to do a full linear table sort which may be considered too computationally expensive. To reduce the computation of computing the probability of all possible game outcomes for all permutations of players seeking a match, the match module may make an initial analysis (e.g., pre-filter prospective player pairings) of the difference in skill levels based on equation (118) and remove those pairings from the match analysis that exceed a simple range check on the skill levels, e.g., the mean skill score μ and/or the difference in mean skill scores (e.g., m_{AB}).

To create a simple range check for player A, the draw quality measure q₂ of equation (117) above is decreasing if either the variance σ_{A} is increasing or if the absolute value of the difference in means |μ_{A}−μ_{B}| is increasing. Specifically, if the uncertainty in the skill of either of the players grows or if the deviation of mean skills grows, the match quality shrinks. In this manner, from player B's point of view:
q₂(m_{AB},σ²_{B},β)≧q₂(m_{AB},ζ²_{AB},β) and
q₂(0,ζ²_{AB},β)≧q₂(m_{AB},ζ²_{AB},β) (119)

Thus, if either of the quality measures q₂(m_{AB},σ²_{B}) and q₂(0,ζ²_{AB},β) are below the critical draw quality measure, then the match module may exclude that pairing since both measures bound the real (but costly to search) matching measure q₂(m_{AB},σ_{B}²,β) from above. More particularly, as long as q₂(m_{AB},σ²_{B},β) or q₂(0,ζ²_{AB},β) are bigger than the critical quality measure, then the match module has not excluded potentially good matches for a player.

The range check of equation (119) may be implemented in any suitable manner. For example, the means p and the variances & for each player A and B may be checked using all three range checks of equations (120), (121) and (122):
μ_{A}<μ_{B}+\sqrt{log(1/q*)−σ²_{B}} (120)
μ_{A}>μ_{B}−\sqrt{log(1/q*)−σ²_{B}} (121)
σ<\sqrt{log(1/q*)−σ²_{B}} (122)

The value of the critical draw quality measure q* may be any suitable value which may be provided as a predetermined or determined value in the match module and/or as a user preference. In some cases, the critical draw quality measure q* may be set such that the logarithm of (1/q*) substantially equals the sum of the variance σ_{B}^{t}+t, where t is either 0 or 1, and where the variance of a player new to the system is set to one. By increasing the value of t, the number of matches or sessions not filtered out is increased until, eventually, all sessions are included.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although the above examples are described with reference to modeling the prior and/or the posterior probability with a Gaussian, it is to be appreciated that the above embodiments may be expanded to allowing arbitrary distributions over players' skill scores, which may or may not be independent. In the above example, the skill covariance matrix is assumed to be a diagonal matrix, i.e., the joint skill distribution is a factorizing Gaussian distribution represented by two numbers (mean and standard deviation) at each factor. In some cases, the covariance matrix may be determined using a low rank approximation such that rank(Σ)=value d. The memory requirements for this operation is O(n˜d) and the computational requirements for all operations in the update technique may be no more than O(n˜d²). For small values of d, this may be a feasible amount of memory and computation, and the approximation of the posterior may be improved with the approximated (rather than assumed) covariance matrix. Such a system may be capable of exploiting correlations between skills. For example, all members of clans of players may benefit (or suffer) from the game outcome of a single member of the clan. The low-rank approximation of the covariance matrix may allow for visualizations of the player (e.g., a player map) such that players with highly correlated skills may be displayed closer to each other.

Moreover, although many of the examples presented herein involve specific combinations of method operations or system elements, it should be understood that those operations and those elements may be combined in other ways to accomplish the same objectives. Operations, elements, and features discussed only in connection with one embodiment are not intended to be excluded from a similar role in other embodiments. Moreover, use of ordinal terms such as “first” and “second” in the claims to modify a claim element does not by itself connote any priority, precedence, or order of one claim element over another or the temporal order in which operations of a method are performed, but are used merely as labels to distinguish one claim element having a certain name from another element having a same name (but for use of the ordinal term) to distinguish the claim elements.

Skill scoring frameworks, such as those described herein, provide opportunities for additional enhancements. For example, one problem that arises when players are being matched up for online game play is that a player having a very high skill score will have fewer other players with which to be matched for competition. However, by introducing handicapping into the skill scoring framework, such a highly skilled player may select one or more game characteristics (e.g., a less than optimal racing vehicle, reduced character capabilities, etc.) and therefore be assigned a handicap that allows the player to be matched with lower skilled players for competitive game play. It should also be understood that handicaps may apply positively or negatively to a player's skill score during the matching stage. As such, a lower skilled player could select an enhanced vehicle or weapon and therefore receive a “positive” handicap in order to be matched with higher skilled players.

Handicapping may be used in many different contexts when matching players for game play. For example, in some implementations, a player's performance may be biased by game-induced or system-induced factors, although other factors may exist. Examples of game-induced factors may include without limitation the type of racing vehicle or character (e.g., warrior, monk, ogre) selected by the user, the type of terrain encountered, the type of weapon used, the player's familiarity with a level or a track geometry, etc. For example, two players may be competing in an auto racing game, where one player is experienced with a particular track geometry and the other is not. The players may agree to handicap the race according to the number of times each player has raced on the particular track geometry. In contrast, examples of system-induced factors may include without limitation network latency, hardware problems with the gaming system, etc. For example, if a first player's network latency is worse than a second player's network latency, the first player's actions may reach the host server later than the second player's actions, even if the first player's acted first at his or her gaming system. The effect is that the first user appears to be reacting a bit slower within the game play than he or she really is—resulting in poor performance relative to players with better network latency. Accordingly, the players may agree to handicap the game according to the detected network latency of the players' gaming systems. In both circumstances, the handicapping may also be enforced by the gaming systems and/or host server, regardless of the player selections.

Handicapping poses at least one obstacle to a skill scoring framework. The game outcome with handicaps is not only a result of the skills of the players involved in the game play but also of the handicaps with which they were playing. However, the effect a handicap may have on a game outcome may be separated from the skills of the players involved. In one implementation, handicapping in a skill scoring framework may be taken into account by introducing one or more virtual players into the game, wherein each virtual player is associated with a real player in the game. As such, each virtual player teamed with a real player can be associated with the handicap assigned to that real player during matching, whether positively or negatively.

Furthermore, each virtual player may be associated with a specific handicap-able characteristic. For example, the real player may be attributed with multiple handicap-able characteristics, such as increased network latency, a less capable racing vehicle as compared to others, etc. A virtual player may be assigned to each of these characteristics and each virtual player can then be teamed with the real player to generate a handicapped skill score for the real player, based on at least one of the handicap-able characteristics.

For example, in a given gaming environment, a real player may be associated with two virtual players: (1) a virtual player providing a handicap for a less capable racing vehicle; and (2) a virtual player providing a handicap for the real player's unfamiliarity with a race course. The skill scores of the real player and the two virtual players are combined to create a handicapped skill score, which is input to a match module that sets up teams and competitors prior to game play. The effect of the virtual players' handicapping skill scores, in this example, is to lower the real player's skill score for matching purposes and for the purpose of updating skill scores after the game has outcome has been determined. As such, the real player may be reasonably matched against lower skilled players. During game play, the handicap-able characteristics attributed to the real player will even out the competition with other lower skilled scored players. Alternatively, the real player may be reasonably teamed with higher skilled players without creating a “superteam”.

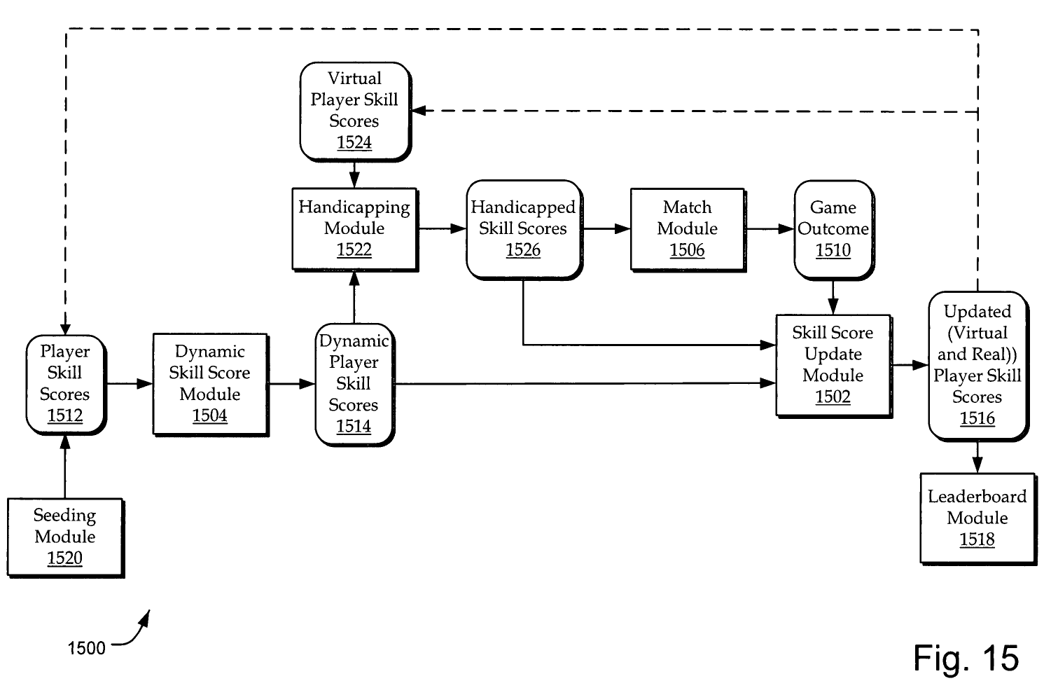

FIG. 15 illustrates an example skill scoring system 1500 for handicapping skill scores in a gaming environment. It should be understood that a skill scoring system may have many applications, including without limitation, matching compatible players on the same team and matching opposing players or teams to obtain an evenly-matched competition. A gaming environment can represent various aspects of game play, including without limitation individual game titles or game modes (e.g., multi-player mode versus campaign mode). A computer gaming environment represents a gaming environment executing in a computer system, including a computing network, a handheld computing device, video game console, a computer gaming server, etc.

A real player's initial skill scores for a particular gaming environment may be set in a variety of ways. In one implementation, a player's initial skill score may be set to a predefined value (e.g., μ=1200 and σ=400). In another implementation, a player's skill scores from one or more other gaming environments (e.g., game titles or game modes) may be input to a seeding module 1520, which influences initial skill scores for that player in a new gaming environment (e.g., a new game title or mode). For example, where a player's skill scores from one previous gaming environment are represented by μ_{seed} and σ_{seed}, the new gaming environment has base skill scores represented by μ_{base} and σ_{base}, and a compatibility factor between the two gaming environments is given by ρ, then the initial skill scores for that player in the new gaming environment can be computed as a linear interpolation between the base skill scores and the seed skill scores.

The skill scoring system 1500 of FIG. 15 includes a seeding module 1520, which receives one or more seed skill scores for a player determined from other gaming environments and computes an initial skill score for the player with reference to a new gaming environment. The initial skill scores are stored as skill scores 1512. The skill scoring system 1500 of FIG. 15 also includes skill score update module 1502, which accepts the outcome 1510 of a game between two or more players (e.g., individual players or teams of players). It should be appreciated that the game outcome may be received through any suitable method. For example, the outcome may be communicated from the player environment, such as an on-line system, to a central processor to the skill scoring system in any suitable manner, such as through a global communication network. In another example, the skill scores of the opposing player(s) may be communicated to the gaming system of a player hosting the skill scoring system. In this manner, the individual gaming system may receive the skill scores of the opposing players in any suitable manner, such as through a global communication network. In yet another example, the skill scoring system may be a part of the gaming environment, such as a home game system, used by the players to play the game. In yet another example, the game outcome(s) may be manually input into the skill scoring system if the gaming environment is unable to communicate the game outcome to the skill scoring system, e.g., the game is a ‘real’ world game such as board chess.

The game outcome 1510 may be an identification of the winning team, the losing team, and/or a tie. For example, if two players (player A and player B) oppose one another in a game, the game outcome may be one of three possible results, player A wins and player B loses, player A loses and player B wins, and players A and B draw. Each player has a skill score 1512, which may be updated to an updated skill score 1516 in accordance with the possible change over time due to player improvement (or unfortunate atrophy) and the outcome of the game by both the dynamic skill score module 1514 and the skill score update module 1502. More particularly, where the player skill scores 1512 is a distribution, the mean and variance of each player's skill score may be updated in view of the outcome and the possible change over time due to player improvement (or unfortunate atrophy). The dynamic skill score module 1504 allows the skill score 1512 of one or more players to change over time due to player improvement (or unfortunate atrophy). The skill score update module 1502, through the outcomes of games, learns the skill score of the player. The player may improve over time, thus, the mean may be increased and/or the variance or confidence in the skill score may be broadened. In this manner, the skill score of each player may be modified to a dynamic player skill score 1514 to allow for improvement of the players. The dynamic player skill scores 1514 may then be used as input to the skill score update module 1502. In this manner, the skill score of each player may be learned over a sequence of games played between two or more players.

The skill score of each player may be used by a player match module 1506 to create matches between players based upon factors such as player indicated preferences, handicaps, and/or skill score matching techniques. In one implementation, a player's skill score that is used by the player match module 1506 may be modified by a handicapping module 1522 with respect to handicap-able characteristics, which are defined, managed, parameterized, and updated in a virtual player skill score datastore 1524. As such, the effective skill score of the player, which is input to the player match module 1506, becomes a handicapped skill score.

The virtual player skill score datastore 1524 may include definitions of virtual players associated with various handicap-able characteristics. For example, each racing vehicle available to a real player may be handicapped relative to a baseline or neutral vehicle. Likewise, a real player's experience with a given racing course may be handicapped relative to a baseline level of familiarity (e.g., a mean number of complete races on the racing course per player globally). In this latter implementation, for example, the player's game console or the hosting server can maintain a count of the number of times the player has competed on the specific racing course and attribute a handicap to the count.

In various implementations, a game designer, a game host, or individual players (e.g., by agreement) may set the initial handicap definitions and parameters for one or more characteristics. The entities that set the handicaps are referred to as “handicappers”. For example, the handicapper may merely identify which characteristics may be handicapped and set the initial skill scores for the corresponding virtual players to zero. Over the course of multiple games, the virtual player's skill scores will be updated in accordance with the game outcomes.

Alternatively, the handicapper may also adjust the initial skill scores for the corresponding virtual players. For example, a handicapper may define μ_{VirtualPlayer}_{_{Vehicle}}=−400 for a less capable vehicle and μ_{VirtualPlayer}_{_{Familiarity}}=−100 if the real player has completed the course less than five times (e.g., as determined by game play records stored at the gaming console, at the host, or at some other game play repository). As such, if a real player selects the less capable vehicle and is assigned to race on a course with which he or she is unfamiliar, virtual players parameterized with negative handicaps may be associated with the real player. The real player's handicapped skill score 1526 may then be computed by:
μ_{Handicapped}=μ_{Player}+μ_{VirtualPlayer}_{_{Vehicle}}+μ_{VirtualPlayer}_{_{Familiarity}} (123)
where μ_{Handicapped} represents the handicapped skill score 1526 for the real player for the purposes of match making, μ_{Player} represents the real player's skill score output from the dynamic skill score's module 1504, μ_{VirtualPlayer}_{_{Vehicle}} represents a virtual player's skill score modifier introduced by the real player's selection of a weaker vehicle, and μ_{VirtualPlayer}_{_{Familiarity}} represents a virtual player's skill score modifier introduced by the real player's lack of familiarity with the selected racing course. The individual handicaps or modifiers may also be passed forward and stored with the handicapped skill scores 1526.

In this example, it is expected that μ_{VirtualPlayer}_{_{Vehicle}} and μ_{VirtualPlayer}_{_{Familiarity}} are negative and will therefore reduce the real player's handicapped skill score 1526 relative to the real player's dynamic player skill score 1514. As such, the real player is more likely to be matched with a lower skilled player who does not suffer the same negative handicaps. Furthermore, the lower skilled players may select a highly capable vehicle or racing course with which they are very familiar to enhance their handicapped skill scores. In this manner, the lower skilled players are more likely to be matched with more highly skilled players.

It should also be understood that the skill scoring framework described herein may be applied to handicapping virtual players as well as to real players. As such, after each game outcome, the skill score for each virtual player associated with a real player in the handicapped skill scores 1526 for the matching is input to the skill score update module 1502. The resulting updated virtual player skill scores 1516 are fed back into the virtual player skill score datastore 1524 for use in future matches.

The matched players, with their dynamic player skill scores 1514, may then oppose one another and generate another game outcome 1510. In some cases, to accurately determine the ranking of a number n of players, at least log(n!), or approximately n log(n) game outcomes may be evaluated. The base of the logarithm depends on the number of unique game outcomes between the two players. In this example, the base is three since there are three possible game outcomes (player A wins, player A lose, and draw). This lower bound of evaluated outcomes may be attained only if each of the game outcomes is fully informative, that is, a priori, the outcomes of the game have a substantially equal probability. Thus, in many games, the players may be matched to have equal strength to increase the knowledge attained from each game outcome. Moreover, the players may appreciate a reasonable challenge from a peer player.

It is to be appreciated that although the dynamic skill score module 1504, the skill score update module 1502, the handicapping module 1522, the player match module 1506 are discussed herein as separate processing modules within the skill scoring system 1500, any function or component of the skill scoring system 1500 may be provided by any of the other processes or components. Moreover, it is to be appreciated that other skill scoring system configurations may be appropriate. For example, more than one dynamic skill scoring module, skill score update module, handicapping module and/or player match module may be provided. Likewise, more than one database may be available for storing skill score, rank, and/or game outcomes. Any portion of the modules of the skill scoring system may be hard coded into software supporting the skill scoring system, and/or any portion of the skill scoring system 1500 may provided by any computing system which is part of a network or external to a network.

A leaderboard module 1518 may be used, in some examples, to determine the ranking of two or more players and may provide at least a portion of the ranking list to one or more devices, such as publication of at least a portion of the leaderboard ranking list on a display device, storing the leaderboard ranking list for access by one or more players, and the like.

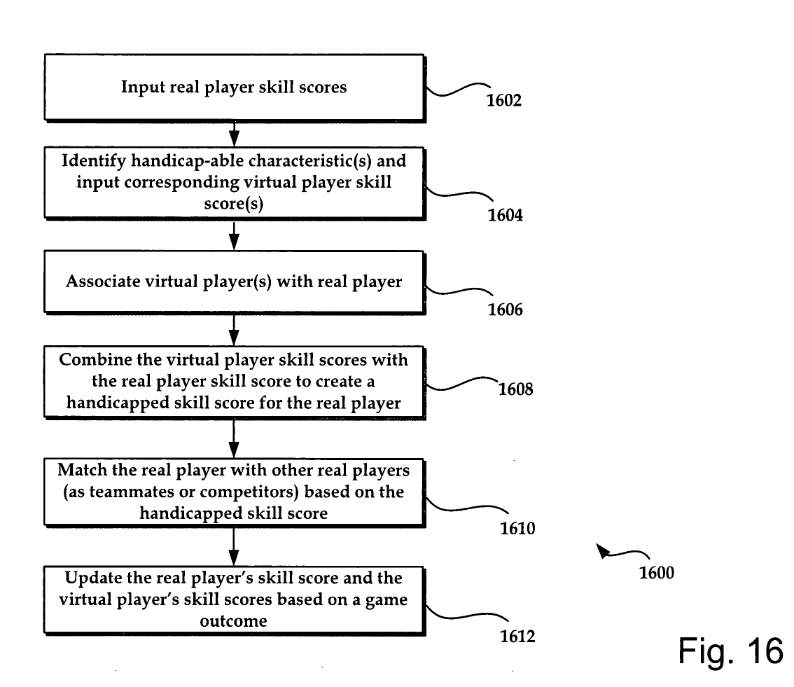

FIG. 16 illustrates example operations 1600 for handicapping skill scores in a gaming environment. An inputting operation 1602 inputs the real player's skill scores, for example, from a seeding module or a skill scores repository. An identification operation 1604 identifies the handicap-able characteristics of the present gaming configuration. For example, the real player may have selected a particularly weak weapons configuration and the game configuration server selected a game map that the real player had never played before. The identification operation 1604 accesses the virtual player skill scores associated with the identified characteristics from a virtual player skill score datastore. These virtual player skill scores are input to a handicapping module along with the real player's skill scores. An association operation 1606 associates the real player with each virtual player. In some implementations, this association locks out other real players in the present game from being teamed with the same virtual player. In this manner, no other real player in the present gaming environment will be simultaneously teamed with the same virtual player. In other implementations, it is possible that the same virtual player is used by different real players, even to the extent that the same virtual player is active in a number of concurrent game sections.

An adjusting operation 1608 combines the virtual player skill score(s) with the real players skill score, such as by adding the μ components of the skill scores, to yield a handicapped skill score. For example, if the virtual player skill score(s) are negative, then the real player's handicapped skill score is lower than his or her original skill score. It should be understood that other methods of combining virtual player and real player skill scores may exist, including any linear combination of the skill scores, taking the minimum or maximum of the skill scores, or any function that reasonably reflects how the individual how the individual skill scores of real and virtual players may combine to result in the skill score of the combined entity.

Using the handicapped skill score for the real player, a matching operation 1610 matches the real player with other players, either teammates or competitors, such as by using the matching techniques discussed herein or another matching technique. An updating operation 1612 updates the real player's skill scores, such as by using the updating techniques discussed herein or another updating technique, based on the game outcome. In one implementation, the skill score of each virtual player used in the associating operation 1606 is also updated by the updating operation 1612. In this manner, the virtual player skill scores can evolve according the game outcomes in which they participated.

What is claimed is:

1. A method comprising:
adjusting a skill score of a player for a gaming environment based on at least one handicap to generate a handicapped skill score;
matching the player for game play with other players in the gaming environment, based on the handicapped skill score of the player.

2. The method of claim 1 wherein the at least one handicap is associated with at least one game-induced factor.

3. The method of claim 1 wherein the at least one handicap represents a predicted effect that at least one game-induced factor is expected to have on performance of the player in the gaming environment.

4. The method of claim 1 wherein the at least one handicap is associated with at least one system-induced factor.

5. The method of claim 1 wherein the at least one handicap represents a predicted effect that at least one system-induced factor is expected to have on performance of the player in the gaming environment.

6. The method of claim 1 wherein the adjusting operation comprises:
summing the skill score of the player and the at least one handicap to generate the handicapped skill score.

7. The method of claim 1 wherein each of the at least one handicap represents a skill score associated with an individual virtual player and the adjusting operation comprises:
teaming the player with each individual virtual player.

8. The method of claim 1 wherein matching operation comprises:
matching the player with another player based on the handicapped skill score of the player and a skill score of the other player.

9. The method of claim 1 further comprising:
updating the skill score of the player based on a game outcome during which the player was matched with another real player based on the handicapped skill score of the player.

10. The method of claim 1 further comprising:
updating the at least one handicap based on a game outcome resulting from a matching of the player with another real player based on the handicapped skill score of the player.

11. The method of claim 1 wherein each of the at least one handicap represents a skill score associated with an individual virtual player and further comprising:
updating the skill score associated with the individual virtual player based on a game outcome resulting from a matching of the player with another real player based on the handicapped skill score of the player.

12. A computer-readable medium having computer-executable instructions for performing a computer process, the computer process comprising:
adjusting a skill score of a real player for a computer gaming environment based on at least one handicap to generate a handicapped skill score;
matching the real player with another real player in the computer gaming environment, based on the handicapped skill score of the real player.

13. The computer-readable medium of claim 12 further comprising:
updating the at least one handicap based on a game outcome resulting from matching the real player with another real player based on the handicapped skill score of the real player.

14. The computer-readable medium of claim 12 wherein each of the at least one handicap represents a skill score associated with an individual virtual player and the computer process further comprises:
updating the skill score associated with the individual virtual player based on a game outcome resulting from matching the real player with another real player based on the handicapped skill score of the real player.

15. The computer-readable medium of claim 12 wherein matching operation comprises:
matching the real player with another real player based on the handicapped skill score of the real player and a skill score of the other real player.

16. The computer-readable medium of claim 12 wherein the skill score of the other real player is also handicapped.

17. A skill scoring system comprising:
a handicapping module that adjusts a skill score of a real player for a gaming environment based on at least one handicap to generate a handicapped skill score;
a matching module coupled to the handicapping module that matches the real player for game play with other real players in the gaming environment, based on the handicapped skill score of the real player.

18. The skill scoring system of claim 17 further comprising:
a skill scoring update module coupled to the matching module that receives a game outcome resulting from matching the real player with at least one other real player based on the handicapped skill score of the real player and updates the at least one handicap based on the game outcome.

19. The skill scoring system of claim 17 wherein each of the at least one handicap represents a skill score associated with an individual virtual player and further comprising:
a skill scoring update module coupled to the matching module that receives a game outcome resulting from matching the real player with at least one other real player based on the handicapped skill score of the real player and updates the skill score associated with the individual virtual player based on the game outcome.

20. The skill scoring system of claim 17 wherein the matching module matches the real player with another real player based on the handicapped skill score of the real player and a skill score of the other real player.
